(19) United States
(12) Patent Application Publication
(10) Pub. No.: US 2012/0030346 A1
(43) Pub. Date: Feb. 2, 2012

(54) METHOD FOR INFERRING EXTENT OF IMPACT OF CONFIGURATION CHANGE EVENT ON SYSTEM FAILURE

(75) Inventors: Satoshi Fukuda, Yokohama (JP); Nobuo Beniyama, Yokohama (JP); Mitsunori Satomi, Tokyo (JP)

(73) Assignee: HITACHI, LTD., Tokyo (JP)

(21) Appl. No.: 12/933,547

(22) PCT Filed: Jul. 29, 2010
(86) PCT No.: PCT/JP2010/062798

§ 371 Date: Sep. 20, 2010

(51) Int. Cl. G06F 15/173

(52) U.S. Cl. 709/224

(57) ABSTRACT

A management system, which manages multiple monitoring target apparatuses, computes a certainty factor denoting the probability that a certain configuration change is the root cause of a performance failure that has occurred in a certain monitoring target apparatus based on rule information, computer system performance information, and a configuration change history, and displays management information from the standpoint of the configuration change based on the computation result.

### TECHNICAL FIELD

The present invention relates to a computer system, and more particularly to a method for avoiding a performance failure.

### BACKGROUND ART

In recent years, computer systems, which comprise multiple apparatuses (for example, server computers, network apparatuses (switches, routers, and so forth), and storage apparatuses), form complex dependency relationships in which network services provided by the respective apparatuses are used by the other apparatuses, making management difficult.

Patent Literature 1 discloses technology in which a management computer detects failures and other such events that occur in multiple apparatuses by monitoring the multiple apparatuses comprising the computer system, and possesses a RCA (Root Cause Analysis) function for inferring the root cause of an event that has occurred. Furthermore, the management computer of this Patent Literature comprises rule information, which, in order to perform this processing, includes one or more types of events as a condition part, and a type of event that can be determined to be the root cause of the respective events described in the condition part in a case where all the events described in the condition part have been detected, and infers a root cause.

### CITATION LIST

### Patent Literature

[PTL 1]

US Patent Application Publication No. 2009/313198

### SUMMARY OF INVENTION

### Technical Problem

In recent years, a computer system configuration may change subsequent to the start of operation. For example, there are events in which the apparatuses comprising the computer system are expanded or the coupling relationships thereamong are updated, and a virtual machine (may be called either a virtual machine or VM hereinafter) is migrated. There are cases in which these configuration changes cause performance failures.

However, in the technology of the Cited Literature 1, whereas it is possible to display information about an apparatus or a component part inside an apparatus, which constitutes the root cause of an event that occurred in a certain apparatus, the user is unable to either identify a cause or obtain a solution to a performance failure from the standpoint of a configuration change.

### Solution to Problem

In order to resolve the above-mentioned problem, a management system, which manages multiple monitoring target apparatuses, computes a certainty factor denoting the probability that a certain configuration change is the root cause of a performance failure that has occurred in a certain monitoring target apparatus based on rule information, computer system performance information, and a configuration change history, and based on the computation result, displays management information from the standpoint of the configuration change (for example, the migration of a representative service component, such as a VM).

### Advantageous Effects of Invention

In accordance with the present invention, in a case where a performance failure has occurred in a computer system, the user is able to identify the cause and obtain a solution from the standpoint of the configuration change, thereby facilitating the management of the computer system.

### BRIEF DESCRIPTION OF DRAWINGS

FIG. 1 is a diagram showing the configuration of a system related to a first example of the present invention.

FIG. 2 is a table of a performance management table 22.

FIG. 3 is a table of an impacting-component table 23.

FIG. 4 is a table of a performance history table 24.

FIG. 5 is a table of a configuration change history table 25.

FIG. 6 is a table of a performance failure history table 26.

FIG. 7 is a table of a root cause history table 27.

FIG. 8 is a table of a performance impact factor table 28.

FIG. 9 is a table of a solvability table 29.

FIG. 10 is a flowchart showing the processing of a component collection program 211.

FIG. 11 is a flowchart showing the processing of an impacting-component program 212.

FIG. 12 is a flowchart showing the processing of a performance monitoring program 213.

FIG. 13 is a flowchart showing the processing of a configuration change monitoring program 214.

FIG. 14 is a flowchart showing the processing of a performance failure monitoring program 215.

FIG. 15 is a flowchart showing the processing of a root cause analysis program 216.

FIG. 16 is a flowchart showing the processing of a performance impact factor computation program 217.

FIG. 17 is a flowchart showing the processing of a solvability computation program 218.

FIG. 18 is a flowchart showing the processing of a screen display program 219.

FIG. 19 is a schematic diagram of when a configuration change occurs.

FIG. 20 is a schematic diagram of a performance impact factor computation.

FIG. 21 is a schematic diagram showing the location where a performance failure has occurred.

FIG. 22 is a diagram showing the time-line for a configuration change/performance failure/RCA/impact factor inference.

FIG. 23 is an association chart of a RCA and impact factor inference.

FIG. 24 is a diagram showing an example of a screen listing configuration changes to be cancelled.

FIG. 25 is a diagram showing an example of a screen of display settings of configuration changes to be cancelled.

FIG. 26 is a diagram showing an example of a screen of the detailed relationships between configuration changes and performance failures.

FIG. 27 is a diagram showing programs and information stored in a storage resource 201 of a management server of a second example.

FIG. 28 is a table of a cancellation setting table 2a.

FIG. 29 is a flowchart showing the processing of an automatic cancellation execution program 21a.

FIG. 30 is a diagram showing programs and information stored in a storage resource 201 of a management server of a third example.

FIG. 31 is a flowchart showing the processing of a display suppression screen display program 21b.

FIG. 32 is a diagram showing programs and information stored in a storage resource 201 of a management server of the first example.

FIG. 33 is a table within monitoring target configuration information 21.

FIG. 34 is a diagram showing a meta-rule.

FIG. 35 is a diagram showing a rule created from the meta-rule and configuration information.

FIG. 36 is a diagram showing a root cause display screen.

FIG. 37 is a diagram showing an example of a computation of the solvability computation program.

### DESCRIPTION OF EMBODIMENTS

An embodiment of the present invention will be explained below based on the drawings. Furthermore, in the following explanation, the information of the examples of the present invention will be explained by using expressions such as “aaa table”, “aaa list”, “aaa DB”, and “aaa queue”, but this information may also be expressed using a structure other than a table, a list, a DB, a queue or other such data structure. For this reason, to show that the information is not dependent on the data structure, an “aaa table”, an “aaa list”, an “aaa DB”, and an “aaa queue” may be called “aaa information”.

In addition, when explaining the content of each piece of information, interchangeable expressions such as “identification information”, “identifier”, “name” and “ID” may be used.

Furthermore, in the following examples, explanations are given using the migration of a VM as an example, but processing for carrying out some sort of service to another computer over a network or processing that can be migrated between server computers may also apply the present invention in the same way. Furthermore, hereinafter, a program, setting information and/or a processor for performing this kind of processing will be called a logical component for a service (a service component). Furthermore, a VM is a virtual computer realized on a server computer, and a program execution result of a VM is sent to (displayed on) either another VM or another computer. Taking this fact into account, the VM is a service component.

Furthermore, a component is either a physical or logical constituent of a monitoring target apparatus. Furthermore, a physical constituent may be called a hardware component, and a logical constituent may be described as a logical component.

### EXAMPLE 1

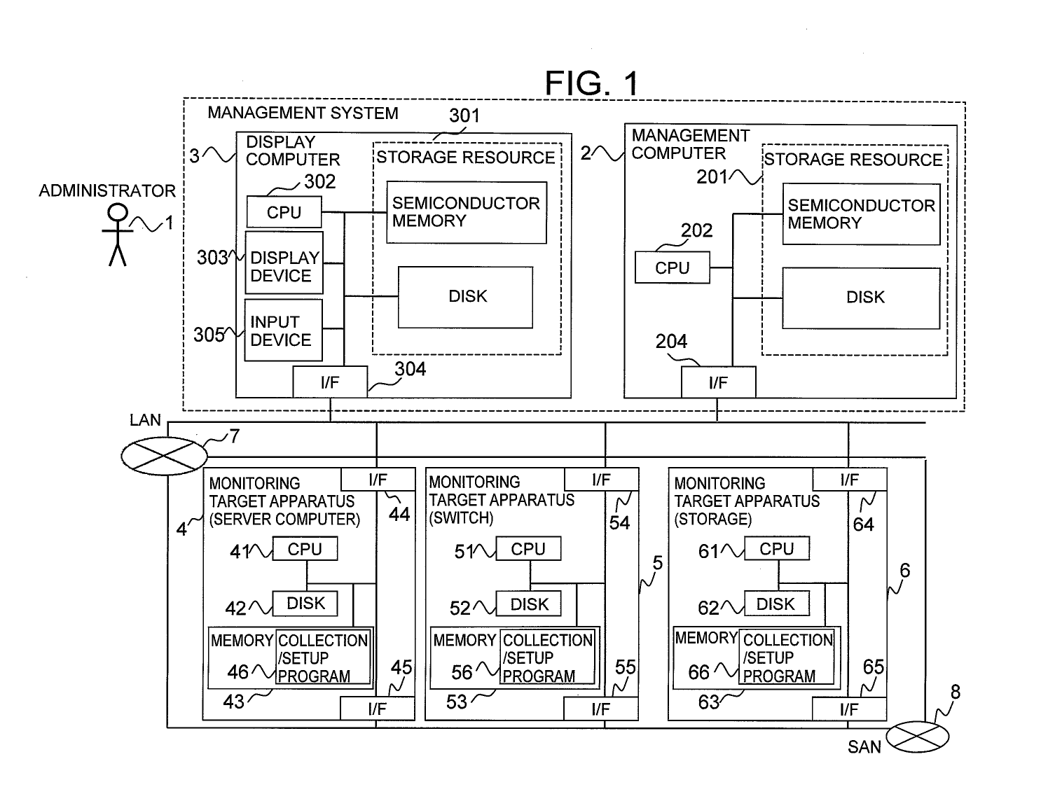

FIG. 1 is a diagram showing the configuration of a computer system related to a first example of the present invention. The computer system comprises a management computer 2, a display computer 3, and multiple monitoring target apparatuses 4 through 6. Furthermore, the apparatus type of the monitoring target apparatus 4 is a server, the apparatus type of the monitoring target apparatus 5 is a switch, and the apparatus type of the monitoring target apparatus 6 is a storage. However, these apparatus types are merely examples. The monitoring target apparatus is coupled to a LAN (Local Area Network) 7, and information referencing and settings are carried out among the respective apparatuses via this LAN 7. Further, the server 4, the switch 5, and the storage 6 are coupled to a SAN (Storage Area Network) 8, and data used in tasks is sent and received among the respective apparatuses via this SAN 8. Furthermore, the LAN 7 and the SAN 8 may be networks of any type, may be separate networks, or may share the same network.

The server 4, for example, is a personal computer, and comprises a CPU 41, a disk 42, which is a storage apparatus, a memory 43, an interface device 44, and an interface device 45. A collection/setup program 46 is stored in the disk 42. The interface devices are abbreviated as I/F in the drawing. When the collection/setup program 46 is executed, this collection/setup program 46 is loaded into the memory 43 and executed by the CPU 41. The collection/setup program 46 collects configuration information, failure information, performance information and the like on the CPU 41, the disk 42, the memory 43, the interface device 44, and the interface device 45. The collection target may also be an apparatus other than the above-described apparatuses. The CPU 41, the disk 42, which is a storage apparatus, the memory 43, the interface device 44, and the interface device 45 will be called components of the server 4. There may also be multiple servers 4.

Furthermore, the disk 42 and the memory 43 may be grouped together and treated as a storage resource. In accordance with this, the information and programs that are stored in the disk 42 and the memory 43 may be handled as though stored in the storage resource. In a case where a storage resource configuration is possible, either the disk 42 or the memory 43 need not be included in the server 4. There may be multiple servers 4.

The switch 5 is an apparatus for coupling multiple servers 4 and the storage apparatus 6, and comprises a CPU 51, a disk 52, which is the storage apparatus, a memory 53, an interface device 54, and an interface device 55. A collection/setup program 56 is stored in the disk 52. When the collection/setup program 56 is executed, this collection/setup program 56 is loaded into the memory 53 and executed by the CPU 51. The collection/setup program 56 collects the configuration information, failure information, performance information and the like of the CPU 51, the disk 52, the memory 53, the interface device 54, and the interface device 55. The collection target may also be an apparatus other than the above-described apparatuses. The CPU 51, the disk 52, which is a storage apparatus, the memory 53, the interface device 54, and the interface device 55 will be called components of the switch 5. There may also be multiple switches 5. Furthermore, instead of the switches 5, either all or a portion of the switches 5 may be another network apparatus, such as a router.

Furthermore, the disk 52 and the memory 53 may be grouped together and treated as a storage resource. In accordance with this, the information and programs that are stored in the disk 52 and the memory 53 may be handled as though stored in the storage resource. In a case where a storage resource configuration is possible, either the disk 52 or the memory 53 need not be included in the switch 5.

The storage 6 is an apparatus for storing data that is used by an application running on the server 4, and comprises a CPU 61, a disk 62, which is a storage apparatus, a memory 63, an interface device 64, and an interface device 65. A collection/setup program 66 is stored in the disk 62. When the collection/setup program 66 is executed, this collection/setup program 66 is loaded into the memory 63 and executed by the CPU 61. The collection/setup program 66 collects the configuration information, failure information, performance information and the like of the CPU 61, the disk 62, the memory 63, the interface device 64, and the interface device 65. The collection target may also be an apparatus other than the above-described apparatuses. The CPU 61, the disk 62, which is the storage apparatus, the memory 63, the interface device 64, and the interface device 65 will be called components of the storage 6. There may also be multiple storages 6.

Furthermore, in a case where the LAN 7 and the SAN 8 form a common network, the interface devices that are coupled to the LAN 7 of respective monitoring target apparatuses and the respective interface devices that are coupled to the SAN 8 side may be used in common.

The monitoring target apparatus may comprise multiple of the same type of components. For example, in the case of the switch, there may be multiple interface devices, and in the case of the storage, there may be multiple disks.

The management computer 2 comprises a storage resource 201, a CPU 202, a disk 203, such as a hard disk apparatus or a SSD apparatus, and an interface device 204. A personal computer is one example of a management computer, but another computer may also be used. The storage resource 201 comprises a semiconductor memory and/or a disk.

Furthermore, the information and programs that are stored in either the disk 203 or the memory 201 may be handled as though stored in the storage resource. In a case where a storage resource configuration is possible, either the disk 203 or the memory 201 need not be included in the management computer 2.

The display computer comprises a storage resource 301, a CPU 302, a display device 303, an interface 304, and an input device 305. A personal computer capable of executing a Web browser is one example of the management computer, but another computer may also be used. Furthermore, the storage resource 301 comprises a semiconductor memory and/or a disk.

The display computer comprises input/output devices such as the display device and input device mentioned above. Examples of an input/output device might be a display, a keyboard, and a pointer device, but a device other than these may also be used. Also, as an alternative to the input/output device, a serial interface or an Ethernet interface may be used as an input/output device, and this interface may substitute for the inputting and displaying of the input/output device by carrying out a display on the display computer and receiving an input by being coupled to a computer for display use comprising a display, a keyboard, or a pointer device, sending display information to the display computer and receiving input information from the display computer input.

Hereinafter, a cluster of one or more computers that manages the computer system and displays display information of the invention of this application will be called a management system. The management computer 2 comprises an input/output device (equivalent to the display device 303 and the input device 305), and in a case where the management computer 2 uses this device to display information for display use, the management computer 2 is a management system. A combination of the management computer 2 and the display computer 3 is also a management system. Furthermore, processing equivalent to that of the management computer 2 may also be realized via multiple computers to make management processing faster and more reliable, and in accordance with this, these multiple computers (to include the display computer 3 in a case where the display computer 3 carries out displays) are a management system.

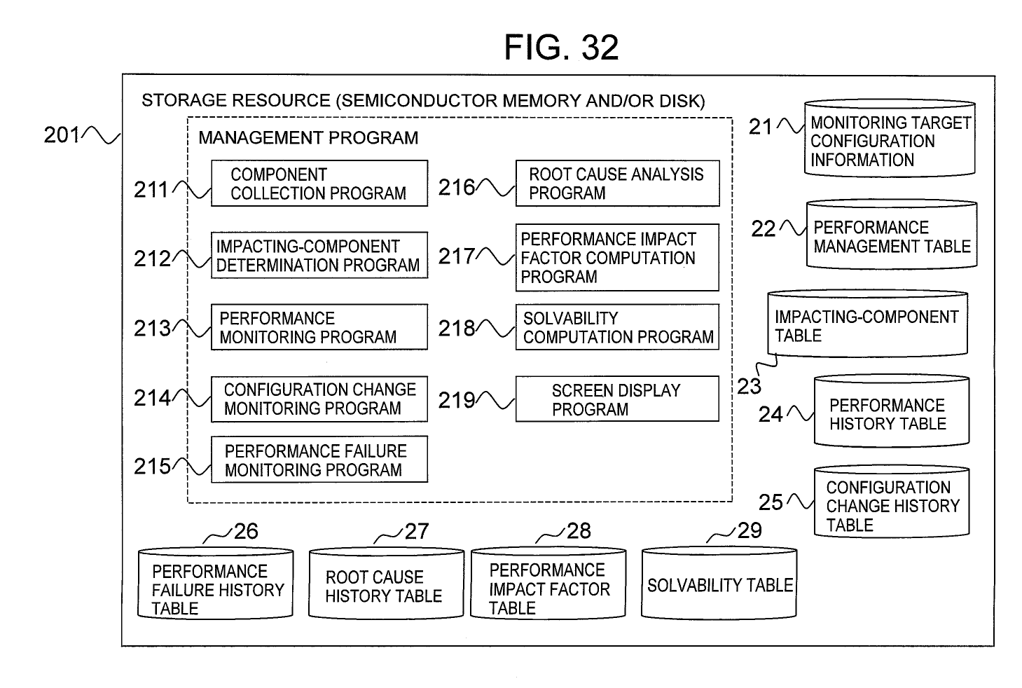

FIG. 32 shows the programs and information stored in the storage resource 201 of the management computer 2.

The storage resource 201 stores a component collection program 211, an impacting-component determination program 212, a performance monitoring program 213, a configuration change monitoring program 214, a performance failure monitoring program 215, a root cause analysis program 216, a performance impact factor computation program 217, a solvability computation program 218, and a screen display program 219. The respective programs are executed by the CPU 202. Furthermore, the respective programs need not each be an individual program file or module, but rather may be grouped together and treated as a management program.

The storage resource 201 also stores monitoring target apparatus configuration information 21, a performance management table 22, an impacting-component table 23, a performance history table 24, a configuration change history table 25, a performance failure history table 26, a root cause history table 27, a performance impact factor table 28, and a solvability table 29. Furthermore, since both the performance management table 22 and the performance history table store information related to performance, either one or both of these tables may be referred to as performance information.

The characteristic functions and operations of the component collection program 211, the impacting-component determination program 212, the performance monitoring program 213, the configuration change monitoring program 214, the performance failure monitoring program 215, the root cause analysis program 216, the performance impact factor computation program 217, the solvability computation program 218, and the screen display program 219 will be explained in detail further below.

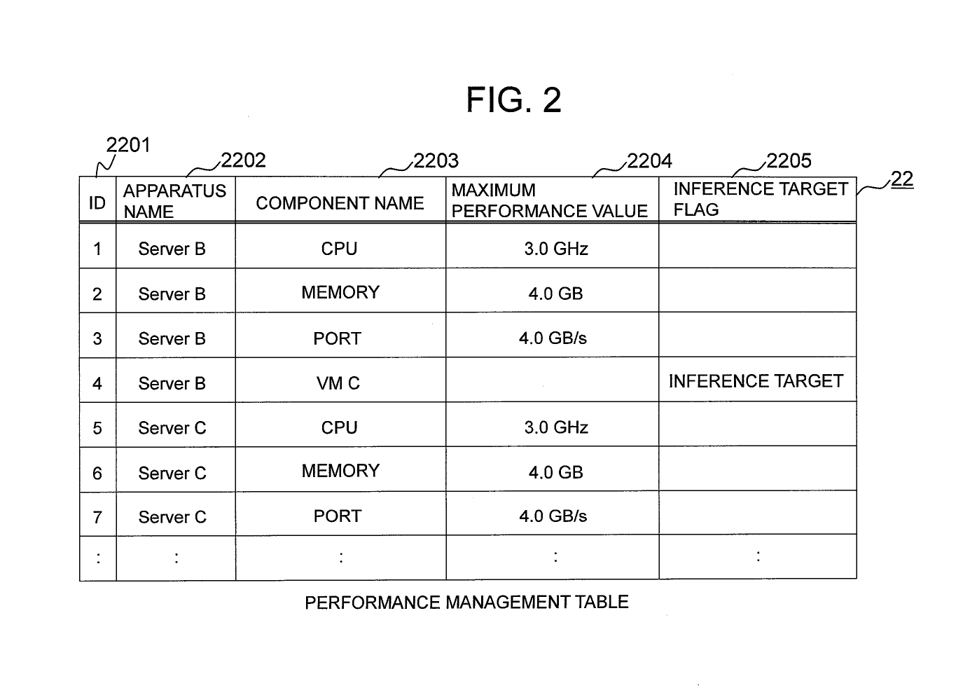

The role of each of the respective tables will be described below using FIG. 33 and FIGS. 2 through 9.

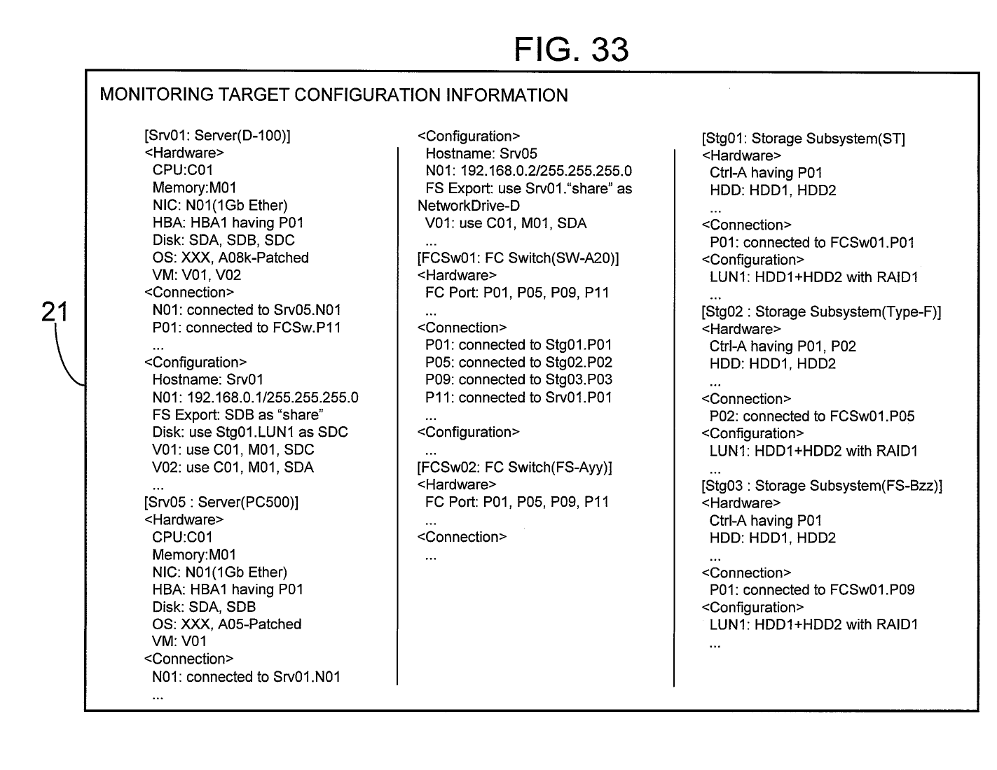

FIG. 33 is a diagram showing an example of the monitoring target configuration information 21. The monitoring target configuration information 21 stores content related to the configuration of the monitoring target apparatuses. The following are examples of the content related to the configuration.

(1) The types and identifiers of the components that comprise each apparatus.

(2) The setting contents of the monitoring target apparatus and the components that comprise the apparatus. This also includes the settings of the server of a predetermined network service (for example, Web, ftp, iSCSI, and so forth).

(3) Coupling relationship between a monitoring target apparatus (or a component comprising this apparatus) and another monitoring target apparatus (or a component comprising this other monitoring target apparatus).

(4) The type of a predetermined network service and the identifier (for example, the IP address and the port number) of the coupling-destination monitoring target apparatus, which are used (may be restated as coupled) in a case where the monitoring target apparatus (or a component of this apparatus) operates as a network client.

FIG. 2 is a diagram showing an example of the performance management table 22. The performance management table 22 stores maximum performance information on the components of monitoring target apparatuses in the computer system, i.e., the server 4, the switch 5, and the storage 6.

An ID 2201 is the unique identifier assigned to each row in the table. An apparatus name 2202 is the unique name of the monitoring target apparatus in the system. A component name 2203 is the unique name of a component (constituent element) in the apparatus. A maximum performance value 2204 is the maximum performance value in a case where the component has a performance value. In a case where the component does not have a performance value, this is left blank. An inference target flag 2205 is a flag denoting whether or not the component is an inference target. In a case where the component is an inference target, in the first example of the present invention, a determination is made as to a component that has an impact on this component from the standpoint of performance, and same is stored in the impacting-component table. Furthermore, since a combination of the apparatus name 2202 and the component name 2203 may point to a component included in the monitoring target apparatus described in the monitoring target configuration information 21, the apparatus name 2202 is the identifier of the monitoring target apparatus stored in the monitoring target configuration information 21, and the component name is the identifier of the component included in the monitoring target apparatus stored in the monitoring target configuration information 21. This is the same for each table and each process explained hereinbelow.

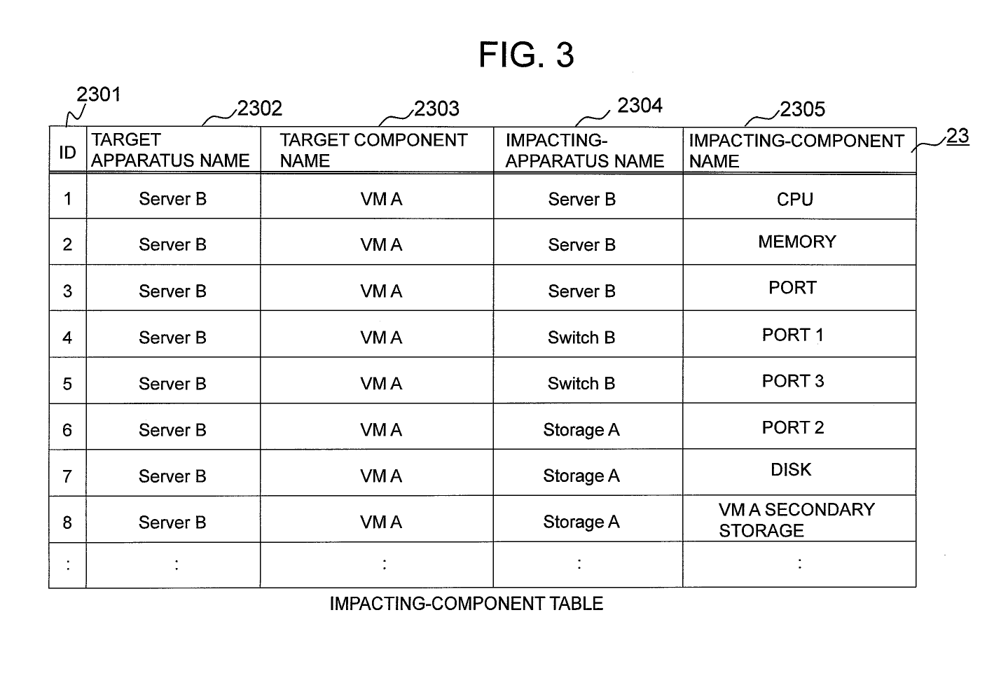

FIG. 3 is a diagram showing an example of the impacting-component table. The impacting-component table 23, in a case where a component (a target component) marked by an inference target flag in the performance management table 22 has undergone a configuration change, stores a computer system component (the impacting-component) that has an impact from the standpoint of performance.

An ID 2301 is the unique identifier assigned to each row in the table. A target apparatus name 2302 is the unique name of the monitoring target apparatus in the system with respect to an apparatus that has a relevant target component. A component name 2303 is the name of the target component. An impacting-apparatus name 2304 is the unique name of the system monitoring target apparatus with respect to an apparatus that has the impacting-component. A component name 2305 is the name of the impacting-component.

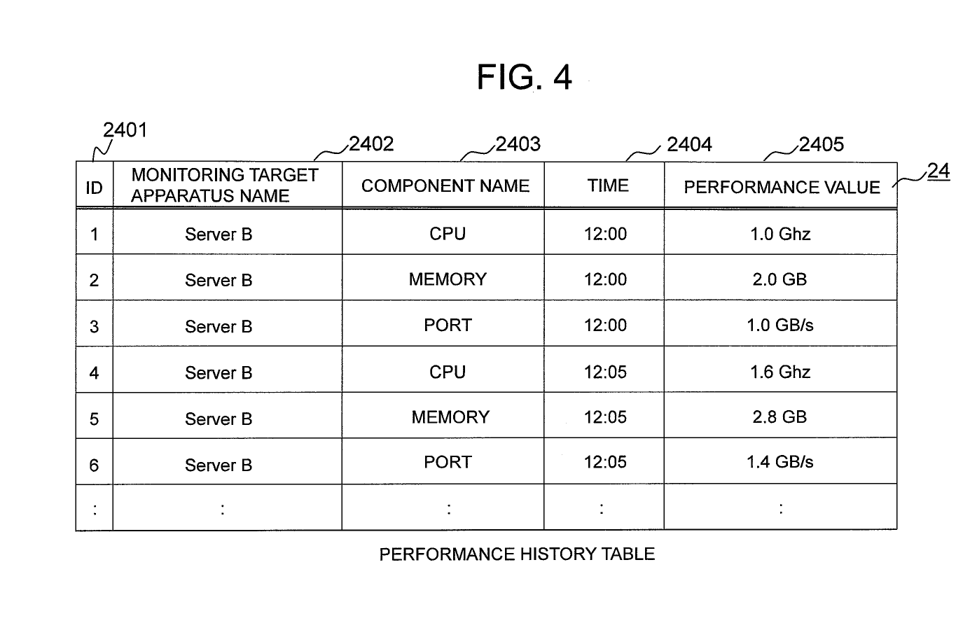

FIG. 4 is a diagram showing an example of the performance history table 24. The performance history table 24 stores performance history information of a component of the performance management table 22.

An ID 2401 is the unique identifier assigned to each row in the table. A monitoring target apparatus name 2402 is the unique name of the system monitoring target apparatus with respect to an apparatus that has a relevant component. A component name 2403 is the name of the component. A time 2404 is the time at which the component performance information was acquired. A performance value 2405 is the performance value of the component at the point in time at which the performance information was acquired.

In this specification, “time” does not only denote a combination of hours, minutes and seconds, but rather may also comprise information identifying a date, such as a year, month and day, and may also comprise a value smaller than a second.

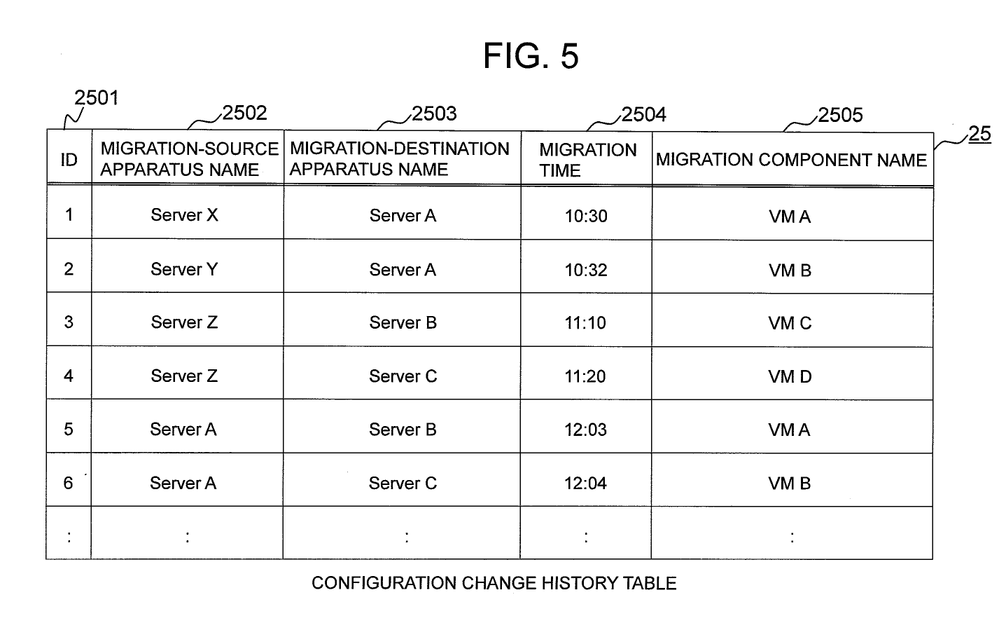

FIG. 5 is a diagram showing an example of the configuration change history table 25. The configuration change history table 25 stores a configuration change history of a component marked with an inference target flag in the performance management table 22.

An ID 2501 is the unique identifier assigned to each row in the table. A migration-source apparatus name 2502 is the unique name of the system monitoring target apparatus with respect to a migration-source apparatus of a relevant component. A component name 2503 is the unique name of the system monitoring target apparatus with respect to a migration-destination apparatus of the component.

A migration time 2504 is the time at which the component underwent a configuration change. A migration-component name 2505 is the name of the component.

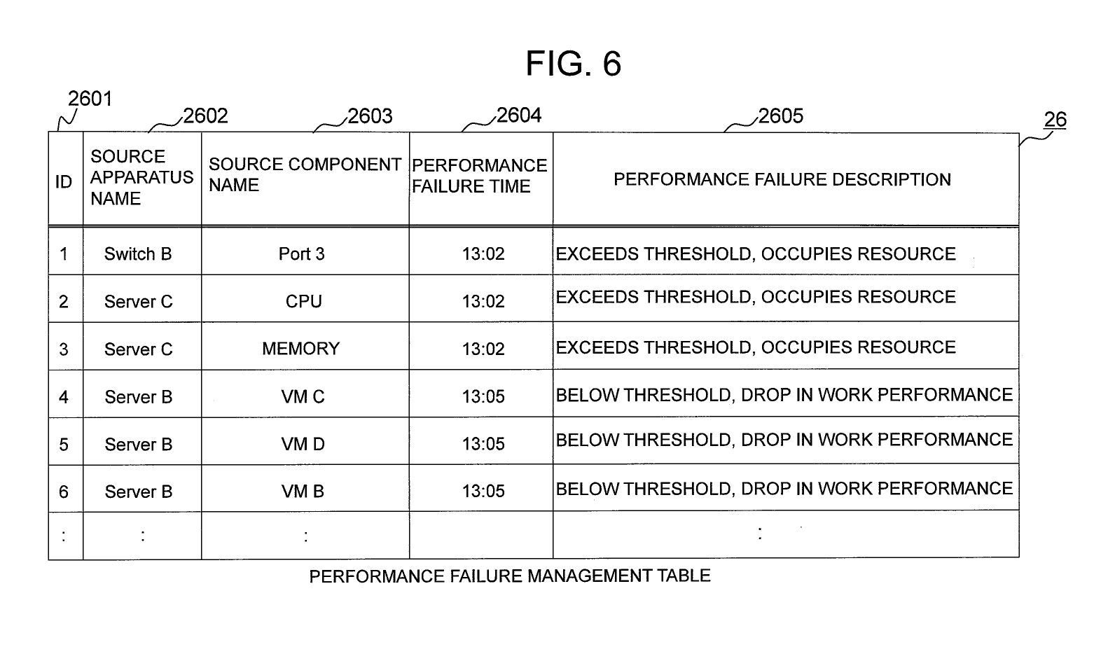

FIG. 6 is a diagram showing an example of the performance failure history table 26. The performance failure history table 26 stores historical information on performance failures that have occurred in the computer system.

An ID 2601 is the unique identifier assigned to each row in the table. A source apparatus name 2602 is the unique name of the system monitoring target apparatus with respect to an apparatus that has a component in which a performance failure has occurred. A source component name 2603 is the name of the component. A performance failure time 2604 is the time at which a performance failure occurred in the component. A performance failure description 2605 is the status of the failure that occurred in the component.

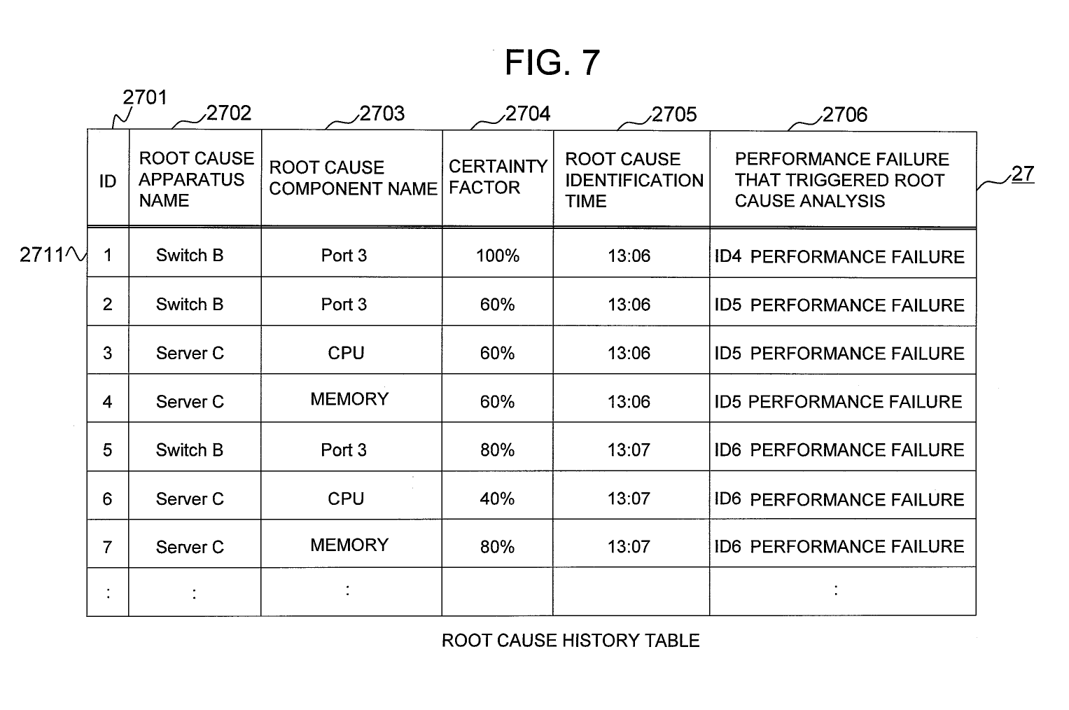

FIG. 7 is a diagram showing an example of the root cause history table. The root cause history table 27 stores historical information on root causes of performance failures that have occurred in the computer system.

An ID 2701 is the unique identifier assigned to each row in the table. A root cause apparatus name 2702 is the unique name of the system monitoring target apparatus with respect to the apparatus identified as the root cause of a performance failure. A root cause component name 2703 is the name of the component identified as the root cause of the performance failure. A certainty factor 2704 is a probability value denoting the probability that the component is the root cause of the performance failure. A root cause identification time 2705 is the time at which the component was identified as the root cause of the performance failure. A performance failure that triggered root cause analysis 2706 is stored as the performance failure with respect to which the ID of the performance failure in the performance failure history table 26 triggers a root cause analysis.

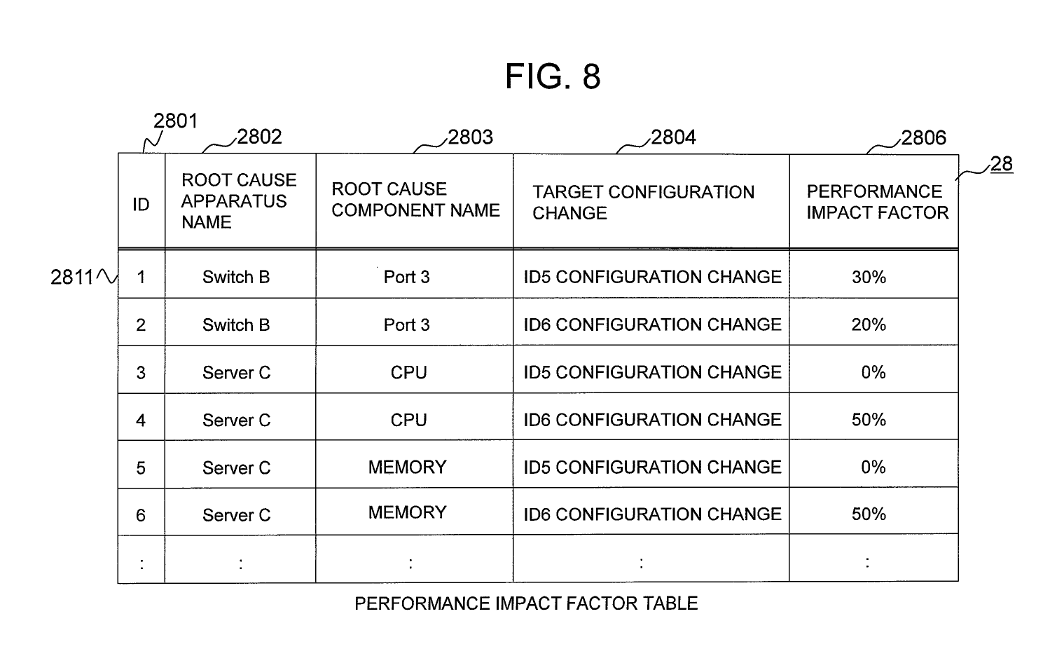

FIG. 8 is a diagram showing an example of the performance impact factor table 28. The performance impact factor table 28 stores each configuration change of the configuration change history table 25 that had an impact from the standpoint of performance with respect to each root cause component registered in the root cause history table 27.

An ID 2801 is the unique identifier assigned to each row in the table. A root cause apparatus name 2802 is the unique name of the system monitoring target apparatus with respect to the apparatus identified as the root cause of a performance failure. A root cause component name 2803 is the name of the component identified as the root cause of the performance failure. A target configuration change 2804 is the configuration change ID stored in the configuration change history table 25. A performance impact factor 2806 stores the extent to which the configuration change has impacted performance as a probability value with respect to the root cause component.

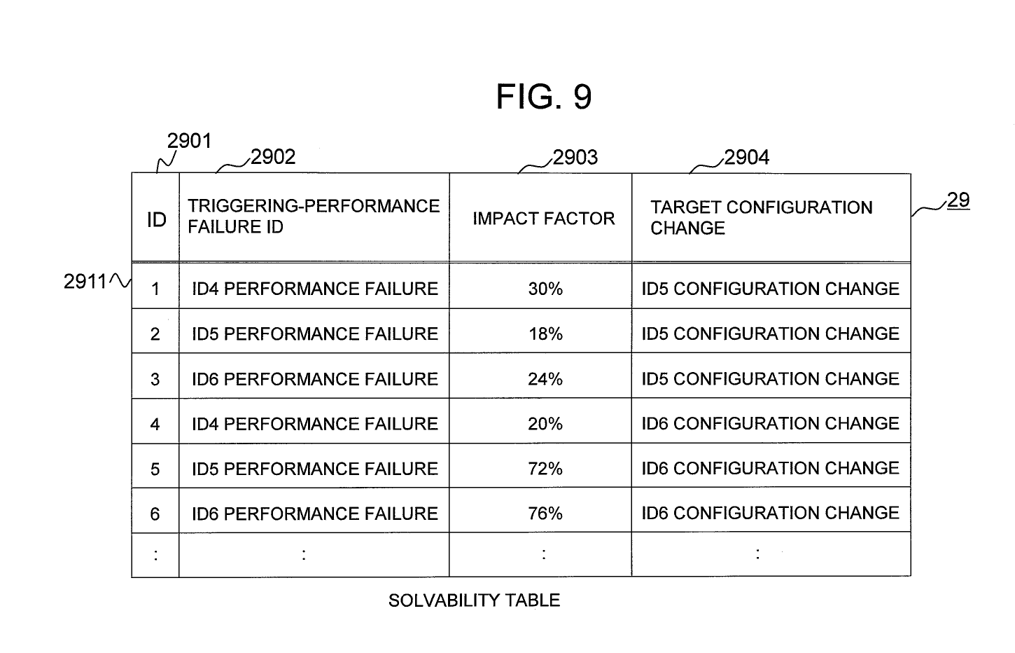

FIG. 9 is a diagram showing an example of the solvability table 29. The solvability table 29 stores a potential for resolving a performance failure that has occurred by cancelling an implemented configuration change.

An ID 2901 is the unique identifier assigned to each row in the table. A triggering-performance failure ID 2902 is the performance failure ID stored in the performance failure table 26. An impact factor 2903 stores the likelihood of the triggering-performance failure ID 2902 being resolved by cancelling the target configuration change 2904 as a probability value. A target configuration change 2904 is the configuration change ID stored in the configuration change history table 25.

The above are the tables that are stored in the storage resource 201. In a case where the tables explained up to this point store the same information, multiple tables may be integrated into a single table. Furthermore, the term event will be used synonymously with performance failure hereinbelow. That is, in the first example of the present invention, information that is handled as a performance failure, in which performance configured by an administrator 1 exceeds a threshold, will be called an event.

The flow of processing when the first example of the present invention infers the extent of the impact of a configuration change event on a system failure in the configuration of FIG. 1 will be explained in detail below by referring to FIGS. 1 through 23.

First, the component collection program 211 will be explained.

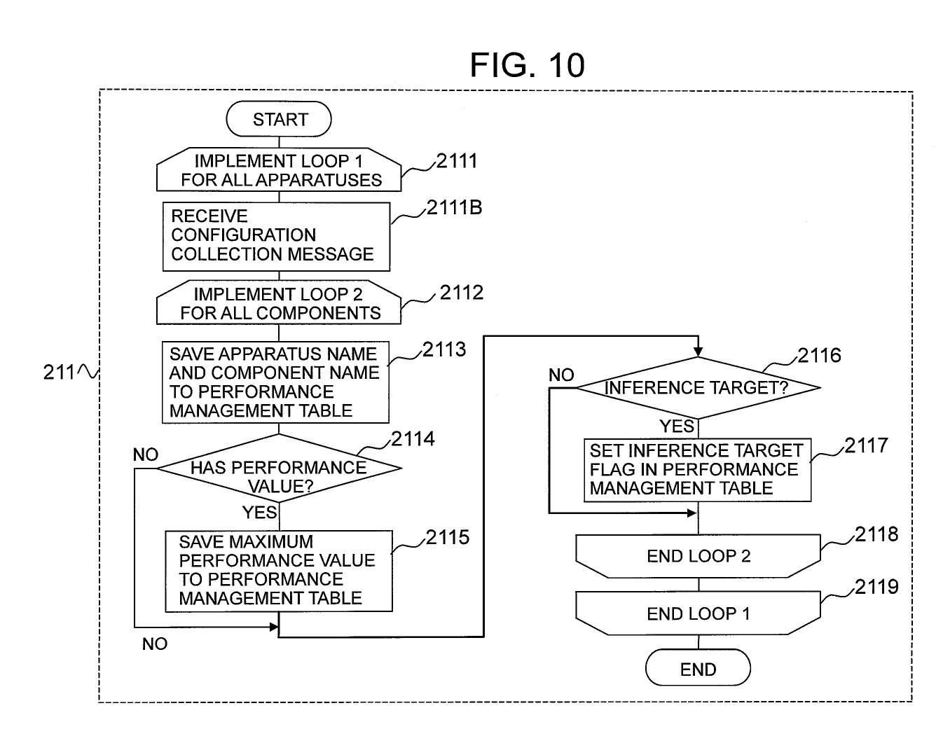

The component collection program 211 will be explained below based on the processing flow of FIG. 10. At a minimum, the trigger for commencing execution of this program can be thought of as the point at which the execution of the management program starts, but cases where a monitoring target apparatus is added and deleted, and a case where the configuration (the content of the configuration is as described hereinabove) of a monitoring target apparatus has been changed may also serve as this trigger.

The component collection program 211 first performs loop processing in accordance with a start loop process 2111 and an end loop process 2119. This loop processing is performed for each of one or more monitoring target apparatuses (hereinafter, called the 2111 loop processing target apparatus) (for example, processes 2112 through 2118 with respect to the server 4, the switch 5, and the storage 6) in the computer system.

In process 2111B, the component collection program 211 receives a configuration collection message denoting either all or a portion of the configuration from the 2111 loop processing target apparatus, and either creates, adds, or updates the contents of the monitoring target configuration information 21 on the basis of this message. Then, the program 211 identifies one or more components comprising the 2111 loop processing target apparatus.

Furthermore, the following examples can be considered as examples of the configuration collection message, but any information that the management program is able to receive and use to identify a configuration may be used.

(*) A message that includes content denoting the type, the identifier, and the configuration of all the components comprising the apparatus.

(*) A message that groups together contents denoting the component identifier and configuration for each component type.

(*) A management program-sent message, which is sent in response to an information collection request that specifies a component identifier, and which denotes the configuration of the specified component.

Next, the explanation will return to the flow of processing of FIG. 10. In process 2112, the loop processing is carried out in accordance with the start loop process 2112 and the end loop process 2118. This loop processing performs processes 2113 through 2117 with respect to each of one or more components (hereinafter called the 2112 loop processing target component) identified in process 2111B. In the following explanation, the expression “inside” may be used as an abbreviation of the expression “included in”.

In process 2113, the component collection program 211 saves the name of the 2111 loop processing target apparatus and the name of the 2112 loop processing target component stored in the monitoring target configuration information 21 to the performance management table 22.

In process 2114, the component collection program 211 determines whether or not the component has the maximum performance value. In a case where the component has the maximum performance value in this determination processing, the component collection program 211 executes process 2115, and in a case where the component does not have the maximum performance value, executes determination process 2116 without executing this process 2115.

In process 2115, the component collection program 211 saves the maximum performance value of this relevant component to the performance management table 22. Furthermore, the component maximum performance value is the value denoted in the configuration collection message, and is the value that exists in at least one or more of all the components that are denoted in this information.

In process 2116, the component collection program 211 determines whether or not the component is an inference target. Whether or not a component is an inference target may be determined by the administrator 1 for each component, or may be determined using a predetermined rule. In this example, it is supposed that in a case where the component is a virtual server, the component is regarded as an inference target. Hereinafter, a virtual server will also be notated as VM (Virtual Machine). In this determination processing, the component collection program 211 executes process 2117 in a case where the component is an inference target, and executes end loop process 2118 without executing this process 2117 in a case where the component is not an inference target.

In process 2117, the component collection program 211 sets a flag in the performance management table 22 when the component is an inference target.

Information on all of the components of the monitoring target apparatuses in the computer system is collected and saved to the performance management table 22 in accordance with the above-described component collection program 211.

Furthermore, each configuration collection message is created by the collection/setup programs 46, 56, 66, and is sent to the component collection program 211 by way of the LAN.

Next, the impacting-component determination program 212 will be explained.

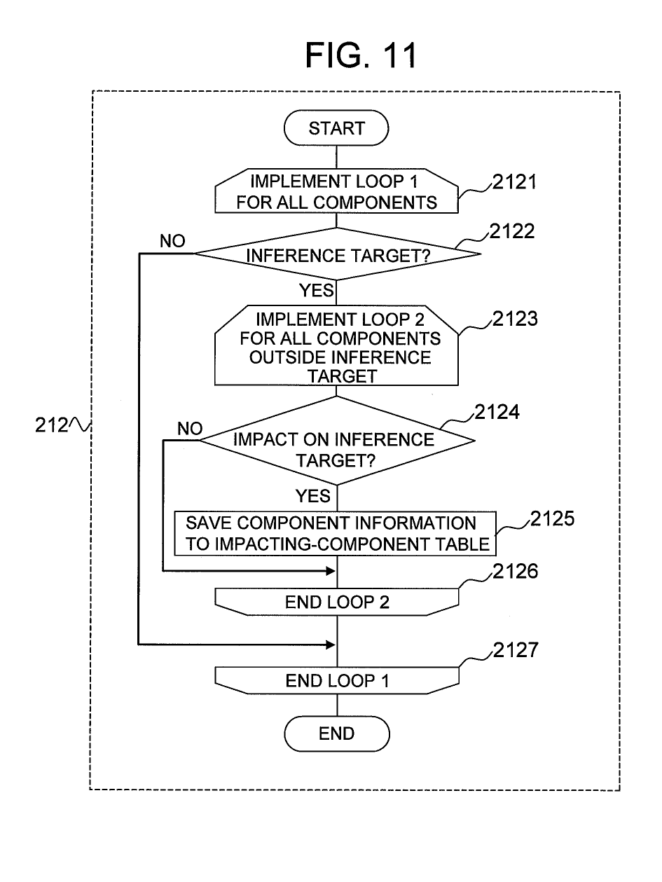

The impacting-component determination program 212 will be explained below based on the processing flow of FIG. 11. The trigger for executing this program may come after the execution of the component collection program 211, in other words, after the monitoring target configuration information 21 and the performance management table 22 have been created.

The impacting-component determination program 212 first performs loop processing in accordance with a start loop process 2121 and an end loop process 2127. This loop processing carries out processes 2122 through 2126 with respect to all the data in the performance management table 22 (hereinafter, called the 2121 loop processing target component).

In process 2122, the impacting-component determination program 212 determines whether or not the component is the inference target component. In this determination processing, the impacting-component determination program 212 executes process 2123 when an inference target flag is set with respect to the component in the performance management table 22, and executes the end loop process 2127 without executing this process 2123 when there is no flag.

In process 2123, the impacting-component determination program 212 performs loop processing in accordance with a start loop process 2123 and an end loop process 2126. This loop processing performs processes 2124 through 2125 with respect to all the components other than the inference target component (hereinafter, called the 2123 loop processing target component). Furthermore, as used here, all the components other than the inference target component in this loop is not limited to the monitoring target apparatus comprising the component, but rather also includes all the components included in other monitoring target apparatuses. However, a portion of the components need not be regarded as 2123 loop processing target components. For example, this corresponds to a case where the component clearly does not impact on the 2121 loop processing target component, or a case where the impact is stochastically small.

In process 2124, the impacting-component determination program 212 determines whether or not the component will have an impact on the inference target component. In this determination processing, the impacting-component determination program 212 executes process 2125 in a case where the component impacts the inference target component, and executes process 2126 without executing this process 2125 in a case where the component does not impact the inference target component.

The determination in process 2124 as to whether or not the component has an impact on the inference target component will be described in detail. For example, in the monitoring target configuration information 21 of FIG. 33, a case in which VM: V01 on Srv01 is the inference target component will be explained. According to the monitoring target configuration information 21, as the configuration information on the Srv01, there is CPU: C01, Memory: M01, NIC: N01 (1 GB Ether), HBA: HBA 1 having P01, DISK: SDA, SDB, SDC, OS: XXX, A08k-Patched, and VM: V01, V02. In accordance with this, all components other than the inference target component comprise the CPU: C01, Memory: M01, NIC: N01 (1 GB Ether), HBA: HBA 1 having P01, DISK: SDA, SDB, SDC, OS: XXX, A08k-Patched, and VM: V02. The relationships of all of the components other than the inference target component with respect to the inference target component V01 will be looked at one at a time. First of all, there is C01, and since there is a description in the monitoring target configuration information 21 that V01: use C01, M01, SDC, it is clear that the C01 will impact on the inference target component V01. Similarly, M01 will also impact on the inference target component V01. As for N01, since the relationship with the inference target component V01 is not clear from the monitoring target configuration information 21, N01 has no impact. Similarly, HBA1, SDA, and SDB do not impact on the inference target component V01. From the description V01: use C01, M01, SDC, the SDC impacts on the inference target component V01. Also, although not a component of the Srv01, based on the description Disk: use Stg01.LUN1 as SDC in the monitoring target configuration information 21, it is clear that the SDC impacts on the Stg01.LUN1. For this reason, it is clear that the Stg01.LUN1 also impacts on the inference target component V01. As for XXX, A08k-Patched and V02, since their relationships with the inference target component V01 are not clear from the monitoring target configuration information 21, they do not have an impact.

In process 2125, the impacting-component determination program 212 saves to the impacting-component table 23 the apparatus name of the inference target component as the target apparatus name 2302, saves the component name of the inference target component as the target component name 2303, saves the apparatus name of the component as the impacting-apparatus name 2304, and saves the component name of the component as the impacting-component name 2305, and executes the next process 2126.

The saving of information to the impacting-component table 23 In process 2125 will be explained in detail. For example, a case where the VM: V01 on the Srv01 in the monitoring target configuration information 21 of FIG. 33 is the inference target component will be explained. Since the C01, M01, SDC, and Stg01.LUN1 are the components that impact on the inference target component V01, information is stored in the impacting-component table 23 for each component that has an impact. For the C01, the target apparatus name is Srv01, the target component name is V01, the impacting-apparatus name is Srv01, and the impacting-component name is C01. Similarly, for the M01, the target apparatus name is Srv01, the target component name is V01, the impacting-apparatus name is Srv01, and the impacting-component name is M01. For the SDC, the target apparatus name is Srv01, the target component name is V01, the impacting-apparatus name is Srv01, and the impacting-component name is SDC. For the Stg01.LUN1, the target apparatus name is Srv01, the target component name is V01, the impacting-apparatus name is Stg01, and the impacting-component name is LUN1.

In accordance with the above-described impacting-component determination program 212, a component that impacts on the inference target component inside the monitoring target apparatus of the computer system is saved to the impacting-component table 23. Although it will be explained in more detail further below, the impacting-component determination program 212 is executed each time a configuration change takes place in the monitoring target apparatus of the computer system.

Next, the performance monitoring program 213 will be explained.

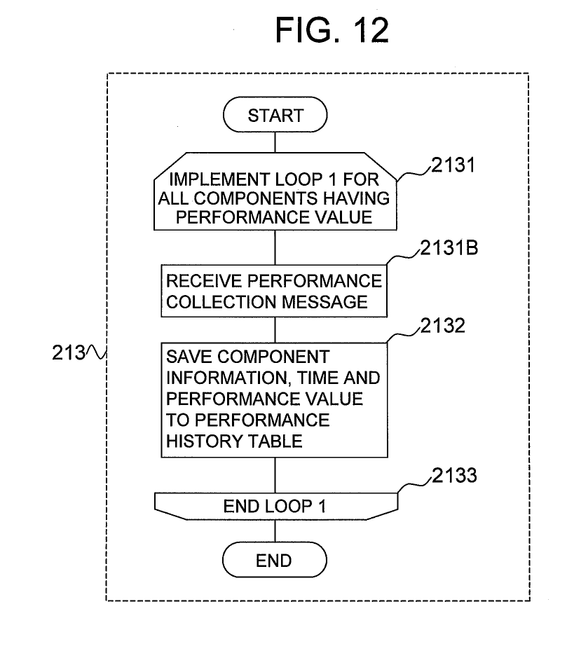

The performance monitoring program 213 will be explained below on the basis of the processing flow of FIG. 12. Furthermore, this program may be executed repeatedly subsequent to the processing of either FIG. 10 or FIG. 11. As an example of repeated execution, execution may be repeated more or less at a frequency of around one time every five minutes.

The performance monitoring program 213 first performs loop processing in accordance with a start loop process 2131 and an end loop process 2133. This loop processing performs process 2132 with respect to all performance value-acquirable components (hereinafter, will be called the 2131 loop processing target component).

In process 2131B, the performance monitoring program 213 receives a performance collection message from the monitoring target apparatus comprising the 2131 loop processing target component. Furthermore, the performance collection message, for example, is a message that is created and sent by the collection/setup programs 46, 56, 66.

In process 2132, the performance monitoring program 213, based on the performance collection message, saves the apparatus name to which the component belongs, the component name, the performance value and the time at which collection was done to the performance history table 24.

In accordance with the above-described performance monitoring program 213, the performance value of a performance value-possessing component of inside the monitoring target apparatus of the computer system is repeatedly saved to the performance history table 24.

Furthermore, the above-mentioned performance collection message denotes the performance value of the 2131 loop processing target component, but the performance values of the components included in the same apparatus may also be grouped together and acquired via a single message. Naturally, all the components in the loop 2131 refers to components that exist in any of multiple monitoring target apparatuses, and ordinarily multiple performance collection messages are received from multiple monitoring target apparatuses.

Also, the following can be considered as examples of the time at which the above-described collection is done, but another time may also be used provided that it is possible to more or less identify the time at which the performance value was measured.

(*) Time at which the program of the monitoring target apparatus measured the performance value. In this case, the performance collection message indicates the time, and In process 2132, the performance monitoring program stores this time, which is included in the message.

(*) Time with respect to the performance monitoring program at which the performance monitoring program 213 received the performance collection message.

(*) Time with respect to the performance monitoring program at which the performance monitoring program 213 saved the performance value to the performance history table.

The configuration change monitoring program 214 will be explained next.

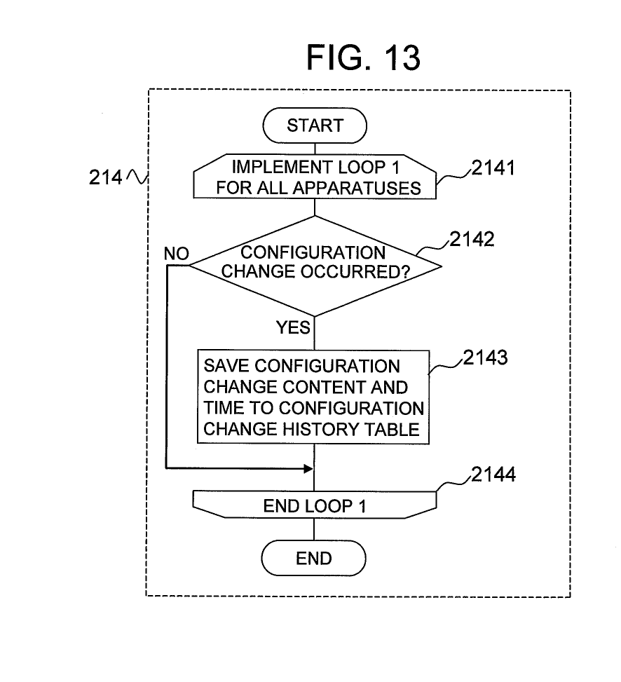

The configuration change monitoring program 214 will be explained below on the basis of the processing flow of FIG. 13. This program may be repeatedly executed subsequent to the processing of either FIG. 10 or FIG. 11. As an example of repeated execution, execution may be repeated more or less at a frequency of around one time every five minutes.

The configuration change monitoring program 214 first performs loop processing in accordance with a start loop process 2141 and an end loop process 2144. This loop processing performs processes 2142 and 2143 with respect to each of multiple monitoring target apparatuses (hereinafter called loop 2141 processing target apparatus) in the computer.

In process 2142, the configuration change monitoring program 214 determines whether or not a configuration change was carried out with respect to the loop 2141 processing target apparatus. As for whether or not a configuration change has occurred, the configuration change monitoring program 214 is able to determine that a configuration change has occurred in a case where the program 214 receives a configuration collection message, and the monitoring contents of the loop 2141 processing target apparatus stored in the current monitoring target configuration information 21 are not the same. In this determination processing, the configuration change monitoring program 214 executes the process 2143 in a case where a configuration change has occurred, and executes the process 2144 without executing this process 2143 in a case where a configuration change has not occurred. Furthermore, as for the configuration content sameness determination, in this processing the contents of the received configuration collection message and the monitoring target configuration information 21 need not be exactly the same, but rather may be regarded as the same even in a case when they are not exactly the same by using a predetermined rule. Furthermore, the sameness check need not be carried out for all of the multiple components of the loop 2141 processing target apparatus.

In process 2143, the configuration change monitoring program 214 saves the contents of the portion of the configuration identified as a configuration change in process 2142 to the configuration change history table 25. This program also updates the monitoring target configuration information 21 and reflects the contents of the configuration change in the loop 2141 processing target apparatus in the same information 21. In this example, the configuration change content is assumed to be the migration of a VM from one server to another server, and a migration-source apparatus name, a migration-destination apparatus name, a migration time, and a migration component name are saved to the configuration change history table 25.

The time 2504 at which the configuration change occurred is also recorded in the configuration change history table 25, and the following are examples of this time. However, the time 2504 may be another time provided it is possible to more or less identify the time at which the configuration change occurred.

(*) Time at which the program of the monitoring target apparatus detected the configuration change. In this case, the configuration collection message indicates the time, and the configuration change monitoring program 214 stores this time, which is included in the message, in the time 2504.

(*) Time with respect to the configuration change monitoring program 214 at which the configuration change monitoring program 214 received the configuration collection message.

(*) Time with respect to the configuration change monitoring program 21 at which the configuration change monitoring program 214 saved the performance value of the contents of the configuration change portion to the performance history table.

In accordance with the above-described configuration change monitoring program 214, configuration changes inside the monitoring target apparatus of the computer system are repeatedly detected and saved to the configuration change history table 25. According to the configuration change monitoring program 214, in a case where a configuration change has been detected, the impacting-component determination program 212 is executed, and the impacting-component table 23 is maintained in the latest state.

The performance failure monitoring program 215 will be explained next.

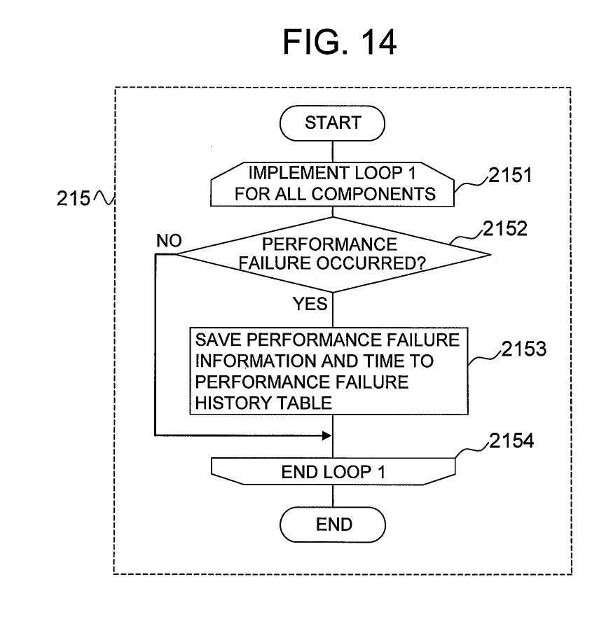

The performance failure monitoring program 215 will be explained below on the basis of the processing flow of FIG. 14. This program may be executed when the performance monitoring program 213 of FIG. 12 receives a performance collection message, or saves a performance value to the performance history table. Another possible trigger is a case where execution is performed repeatedly (for example, more or less one time every five minutes).

The performance failure monitoring program 215 first performs loop processing in accordance with a start loop process 2151 and an end loop process 2154. This loop processing performs processes 2152 and 2153 with respect to each of multiple components (hereinafter called loop 2151 processing target components), which are included in multiple monitoring target apparatus on the compute system, and which comprises performance values.

In process 2152, the performance failure monitoring program 215 determines whether or not a performance failure has occurred in a loop 2151 processing target component. The determination processing is able to determine that a performance failure has occurred in a case where a performance value for a loop 2151 processing target component of the performance history table is a value equal to or larger than a value obtained by multiplying a predetermined percentage (to include 1, of course) by the maximum performance value in the performance management table 22. In this determination processing, the performance failure monitoring program 215 executes the process 2153 in a case where a performance failure has occurred, and executes the process 2154 without executing this process 2153 in a case where a performance failure has not occurred.

In process 2153, the performance failure monitoring program 215 saves a performance failure source apparatus name, a performance failure source component name, a performance failure time, and performance failure information collected from the collection/setup programs 46, 56, 66 to the performance failure history table 26.

In accordance with the above-described performance failure monitoring program 215, a performance failure inside a monitoring target apparatus of the computer system is detected and saved to the performance failure history table 26.

FIG. 6 shows the performance failure history table 26. Columns 2601 through 2605 are stored in accordance with the process 2153.

Next, the root cause analysis program 216 will be explained.

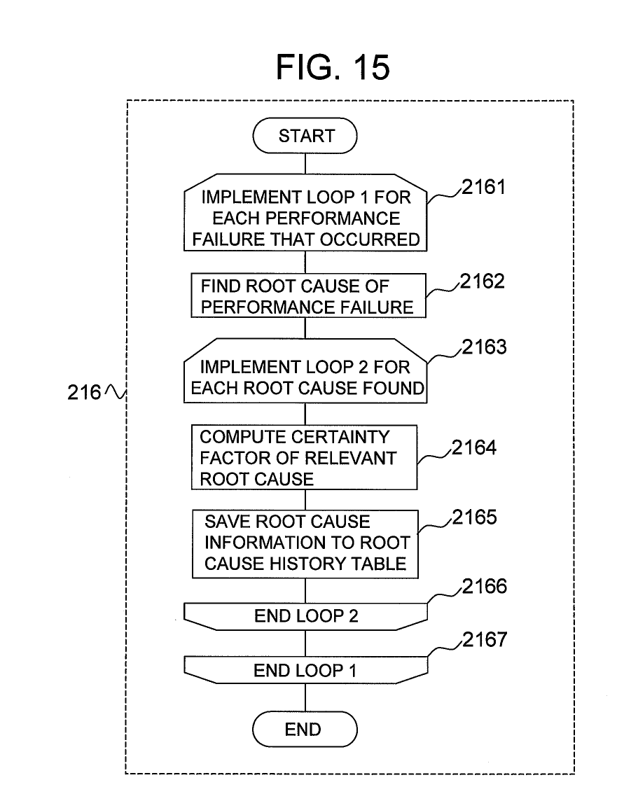

The root cause analysis program 216 will be explained below on the basis of the processing flow of FIG. 15. This program may be executed either when a performance failure is detected In processing of FIG. 14 or when execution is simply performed repeatedly.

The root cause analysis program 216 first performs loop processing in accordance with a start loop process 2161 and an end loop process 2167. In this loop processing, the root cause analysis program 216 executes processes 2162 through 2166 for each performance failure detected by the performance failure monitoring program 215. Furthermore, this loop is not necessary in a case where the execution of this program was triggered by the detection of a performance failure.

In process 2162, the root cause analysis program 216 determines the root cause of the performance failure, and executes the next process 2163. The root cause is identified by comparing information on the performance failure that occurred, and information in the performance management table 22 and the impacting-component table 23 to a predefined rule.

In process 2163, the root cause analysis program 216 performs loop processing in accordance with a start loop process 2163 and an end loop process 2166. This loop processing performs processes 2164 and 2165 with respect to each of one or more determined root causes (hereinafter will be called the loop 2163 processing target root cause).

In process 2164, the root cause analysis program 216 computes a certainty factor for the loop 2163 processing target root cause, and executes the next process 2165. The root cause certainty factor is a value denoting a probability as to whether or not the determined root cause is really the root cause, and is expressed as a percentage. More specifically, the certainty factor is a value for which a higher value denotes greater certainty, but this does not have to be the case.

In process 2165, the root cause analysis program 216 saves the apparatus name and component name of the determined root cause, the relevant certainty factor, the time at which the root cause was identified, and the performance failure that triggered the root cause analysis to the root cause history table 27. One example of the time at which the root cause was identified is the time at which this program was executed.

In accordance with the above-described root cause analysis program 216, the root cause of a performance failure that occurred inside the monitoring target apparatus of the computer system is determined and saved to the root cause history table 27.

Furthermore, the following denotes an example of the root cause identification of the process 2162 and the certainty factor computation. In this computation example, a program called the root cause analysis program (hereinafter called the RCA) is used.

The RCA is a ruled-based system, and comprises a condition part and a conclusion part. The condition part and the conclusion part are created from a pre-programmed meta-rule and the latest configuration information (past configuration information is not used).

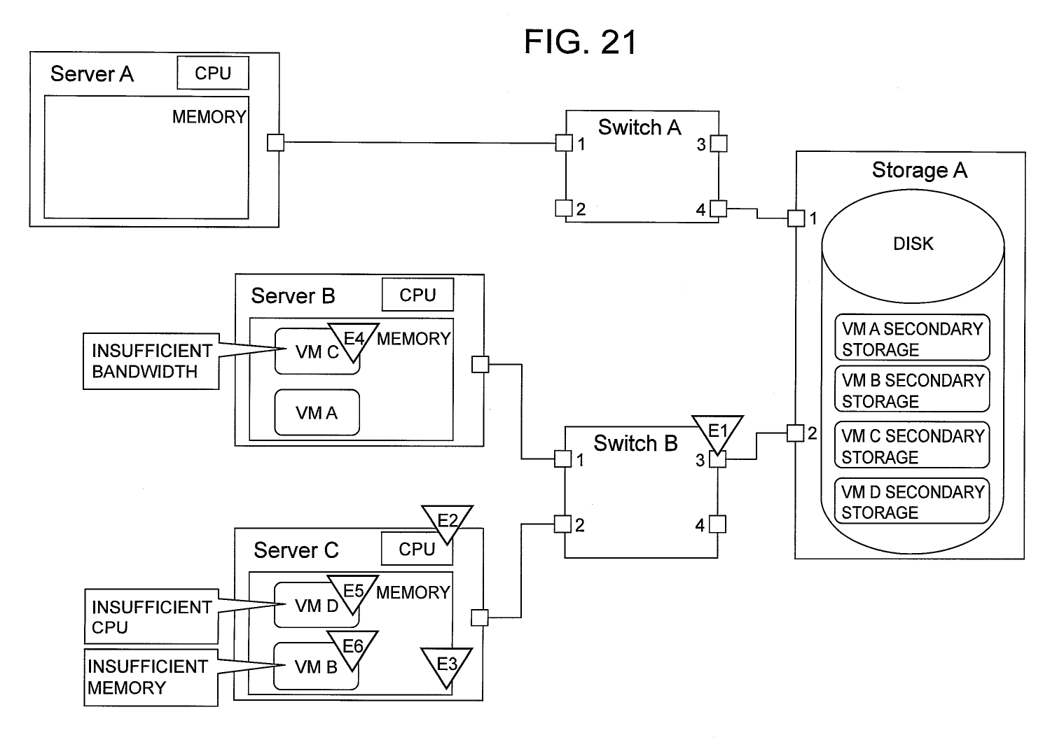

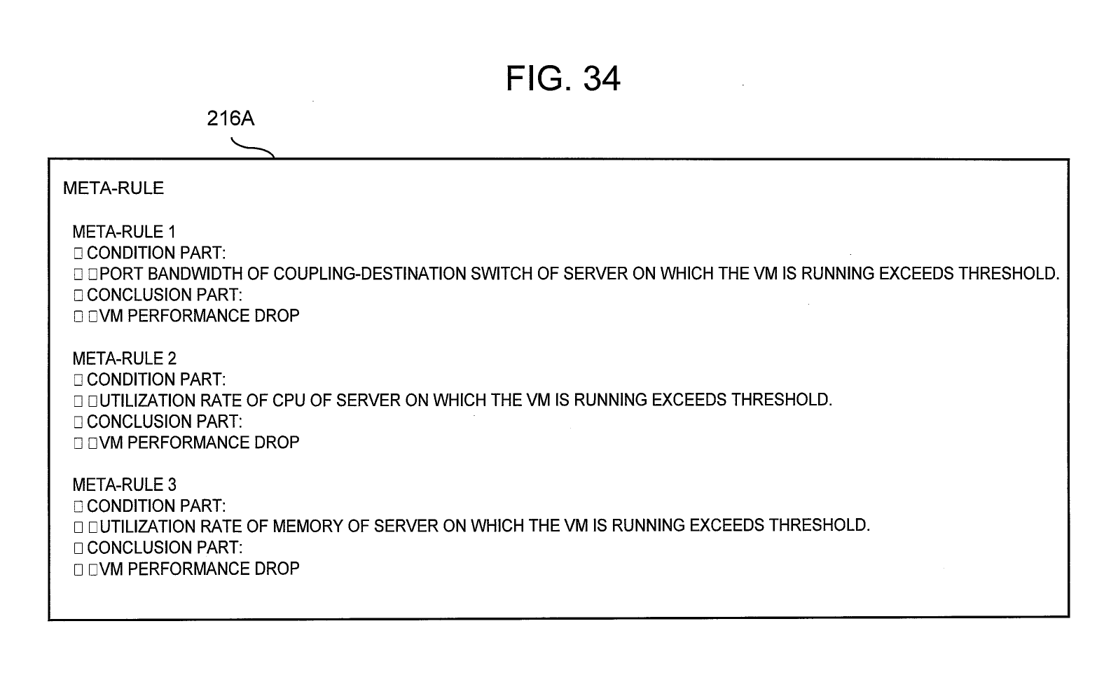

An example of a meta-rule is shown in FIG. 34, and an example of the latest configuration information is shown in FIG. 21.

In the meta-rule 216A, general rules that do not rely on a specific configuration are described. For example, these are as follows.

(Meta-Rule 1)

Condition Part:

The port bandwidth of the coupling-destination switch of the server on which this VM is running exceeds the threshold.

Conclusion Part:

There is a drop in VM performance.

The RCA uses a rule created by replacing the VM, the server, the coupling-destination switch, and the port in this meta-rule with specific configuration information.

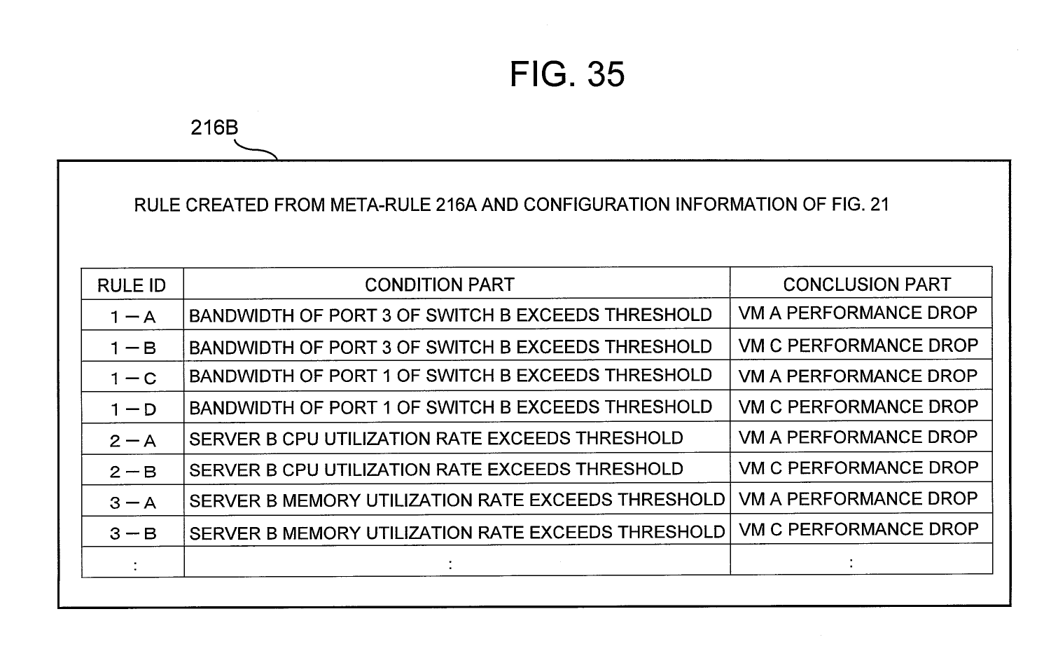

An example of a rule created by replacing the meta-rule 216A with the configuration information of FIG. 21 is shown in 216B of FIG. 35.

In rule 1-A, the meta-rule 1 is replaced with the configuration VM C, Server B, Switch B, and Port 3 of FIG. 21. For example, this is as follows.

(Rule 1-A)

Condition Part:

The bandwidth of port 3 of switch B exceeds the threshold.

Conclusion Part:

There is a drop in VM A performance.

It goes without saying that the meta-rule 216 is stored in the storage resource 201. The created rule 216B may also be stored in the storage resource 201. However, rule 216B may also be considered an intermediate product. In accordance with this, the rule 216B does not always have to be stored in the storage resource 201.

The RCA uses the rule to analyze a root cause. The RCA assigns a certainty factor to the root cause at this time. In this example, the RCA assigns a number of certainty factors that conforms to the rule.

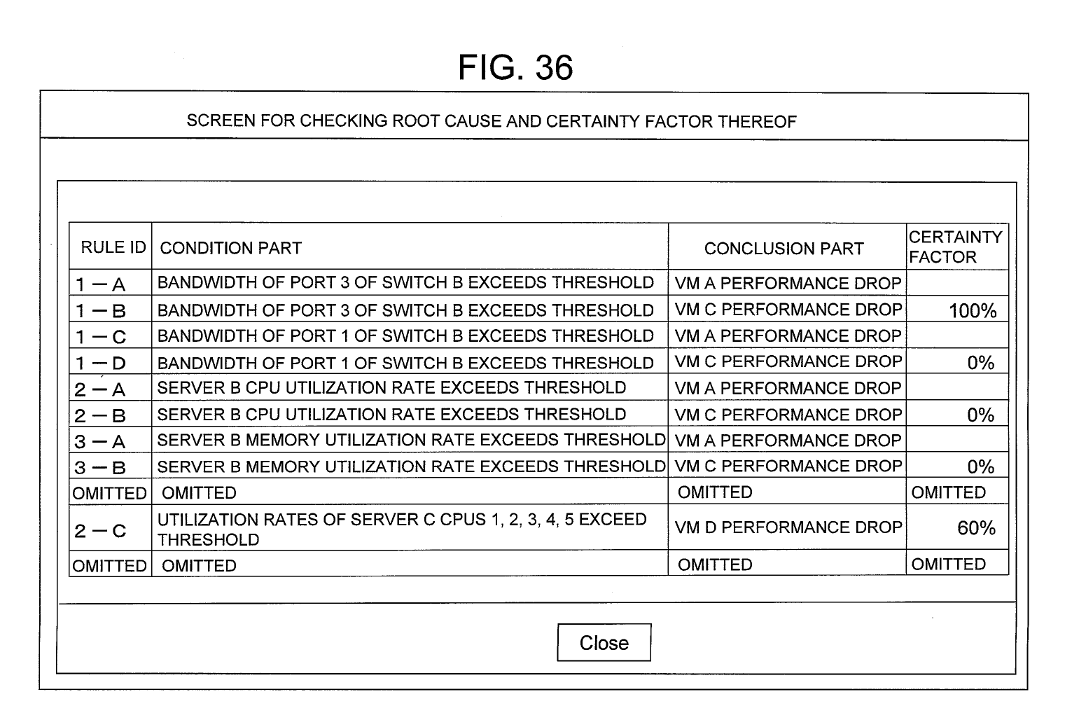

The root causes and their certainty factors of FIG. 36 will be explained using a confirmation screen.

In a case where the bandwidth of port 3 of switch B exceeds the threshold when a drop in performance occurs in VM C, the certainty factor of the rule 1-B is 100%.

The VM C appears in the conclusion part for 1-D, 2-B, and 3-B, but because the condition part does not match, the certainty factor is 0%.

Furthermore, in a case where a performance drop occurs in VM D and the CPU utilization rates of CPUs 1, 2, and 3 of Server C have exceeded the threshold, the certainty factor of rule 2-C becomes 60%. This becomes 60% because three of the five CPUs include in the rule 2-C match the rule.

The root cause identification of the process 2162 and the certainty factor computation are carried out as described hereinabove.

Next, the performance impact factor computation program 217 will be explained.

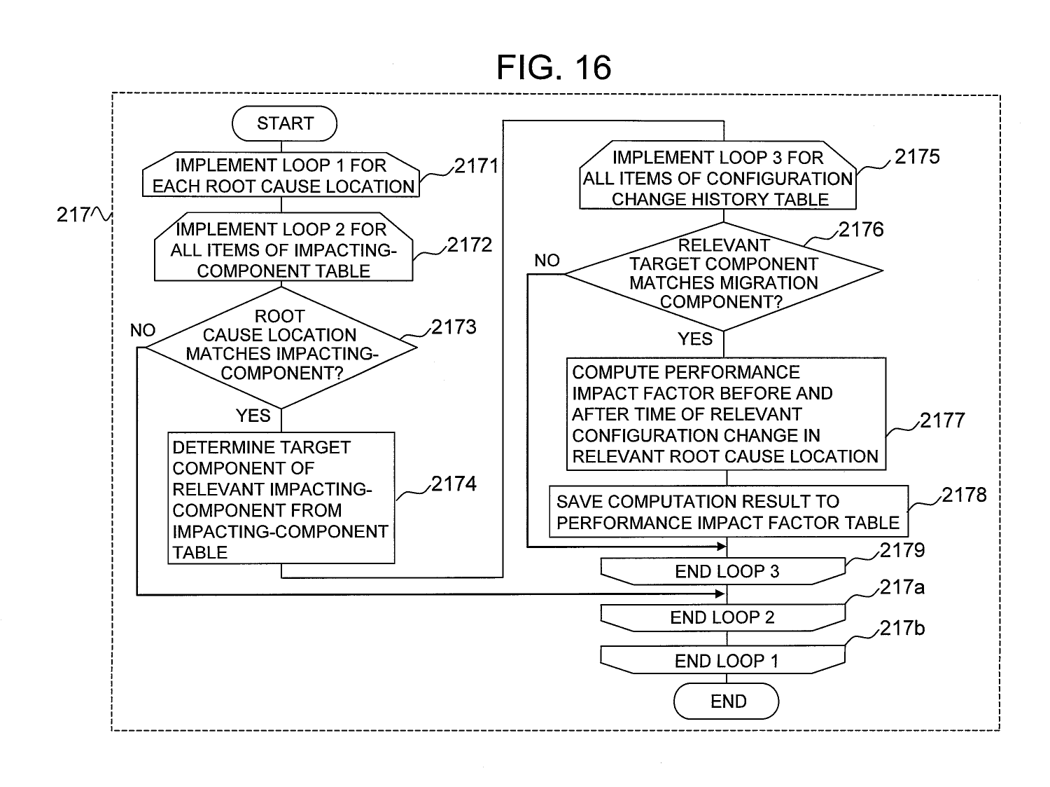

The performance impact factor computation program 217 will be explained below on the basis of the processing flow of FIG. 16. This program, for example, is executed after the root cause analysis program 216 has identified the root cause.

The performance impact factor computation program 217 first performs loop processing in accordance with a start loop process 2171 and an end loop process 217b. In this loop processing, the performance impact factor computation program 217 executes processes 2172 through 217a with respect to each of multiple root cause locations (hereinafter called loop 2171 processing target root cause locations) detected by the root cause analysis program 216. Furthermore, a root cause location detected by the root cause analysis program 216 refers to a combination of the root cause apparatus name 2702 and the root cause component name 2703 of the root cause history table 27. In a case where “root cause location stored (or included, existing) in the root cause history table 27” expresses the same meaning, this expression will similarly refer to a combination of the apparatus name 2702 and the component name 2703. Furthermore, in a case where it is possible to identify the monitoring target apparatus using only the root cause component name 2703, the apparatus name 2702 need not be included as the relevant location.

In process 2172, the performance impact factor computation program 217 performs loop processing in accordance with a start loop process 2172 and an end loop process 217a. This loop processing is implemented with respect to all of the records in the impacting-component table 23 (the loop 2172 processing target record hereinafter) and performs processes 2173 through 2179. A record in table 23 constitutes a row of this table.

In process 2173, the performance impact factor computation program 217 determines whether the loop 2171 processing target root cause location and the impacting-location of the loop 2172 processing target record (uniquely determined in accordance with the impacting-apparatus name 2304 and the impacting-component name 2305) match. In this determination processing, the performance impact factor computation program 217 executes the process 2174 in a case where the loop 2171 processing target root cause component matches the loop 2172 processing target record impacting-component, and when this is not the case, executes process 217a without executing the processes 2174 through 2179.

In process 2174, the performance impact factor computation program 217 determines the target apparatus (the target apparatus name 2302 and the target component name 2303) that is described in the same row as the impacting-location that was a match In process 2173 in the impacting-component table 23, and executes the next process 2175.

In process 2175, the performance impact factor computation program 217 performs loop processing in accordance with a start loop process 2175 and an end loop process 2179. This loop processing performs processes 2176 through 2178 with respect to all of the records in the configuration change history table 25 (hereinafter called the loop 2175 processing target record). A record in table 25 constitutes a row of this table.

In process 2176, the performance impact factor computation program 217 determines whether the target component determined in process 2174 matches the migration component (uniquely determined in accordance with the migration-destination apparatus name 2503 and the migration component name 2505) of the loop 2175 processing target record, and determines whether a configuration change has occurred in the target component. In this determination processing, the performance impact factor computation program 217 executes process 2177 in a case where the target component matches the migration component in the configuration change history table 25, and executes process 2179 without executing the processes 2177 through 2178 in a case where the target component does not match the migration component in the configuration change history table 25.

In process 2177, the performance impact factor computation program 217 computes the performance impact factors of before and after the time of the configuration change with respect to the root cause component, and executes the next process 2178.

In process 2178, the performance impact factor computation program 217 saves the target component determined in process 2174 to the root cause apparatus name 2802 and the root cause component name 2803, saves ID2501 of the configuration change history table 2501 to which the migration component belongs to the target configuration change 2804, and saves the performance impact factor 2806 determined in process 2177 to the performance impact factor table 28.

In accordance with the above-described performance impact factor computation program 217, the performance impact factors of before and after a configuration change with respect to the root cause location are determined, and are saved to the performance impact factor table 28.

Furthermore, the above-described performance impact factor is a value denoting the performance impact factor applied to a specific member before and after a specific configuration change has occurred. The following may be given as an example of the equation for computing the performance impact factor.

Performance impact factor (%)=(performance value of member after configuration change−performance value of member before configuration change) divided by maximum performance value of member×100

For example, the following case will be considered.

Configuration change: VM A migrates from Server A to Server B

Member: Port 3 of Switch B

Performance values:

Performance value of Port 3 of Switch B prior to VM A migration is 2.4 Gbps

Performance value of Port 3 of Switch B subsequent to VM A migration is 3.6 Gbps

Maximum performance value of Port 3 of VM A Switch B is 4.0 Gbps

The performance impact factor in this case is as follows.

Performance impact factor=(3.6 Gbps−2.4 Gbps) divided by 4.0 Gbps×100=30%

Next, the solvability computation program 218 will be explained.

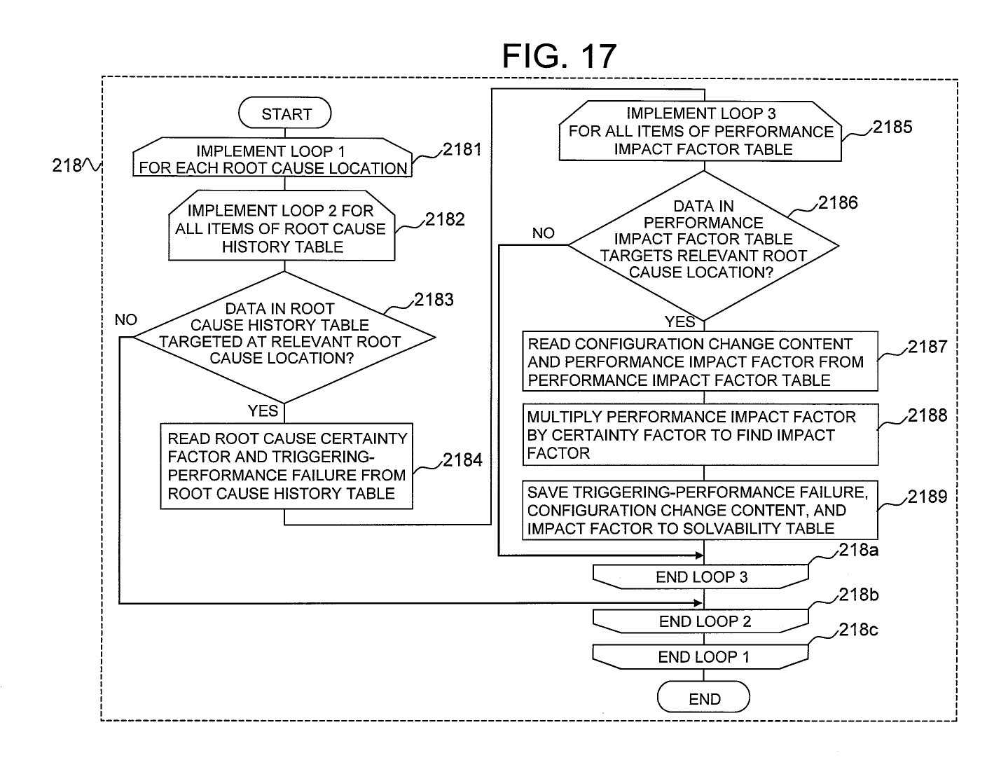

The solvability computation program 218 will be explained below on the basis of the processing flow of FIG. 17. This program is executed one or more times after the root cause analysis program 216 of FIG. 15 has been executed at least one time.

The solvability computation program 218 first performs loop processing in accordance with a start loop process 2181 and an end loop process 218c. In this loop processing, the solvability computation program 218 executes processes 2182 through 218b with respect to each of one or more root cause locations (hereinafter called the loop 2181 processing target root cause location) detected by the root cause analysis program 216.

In process 2182, the solvability computation program 218 performs loop processing in accordance with a start loop process 2182 and an end loop process 218b. This loop processing is implemented with respect to all of the records in the root cause history table 27, and performs processes 2183 through 218a. A record in the root cause history table 27 constitutes a row of this table.

In process 2183, the solvability computation program 218 determines whether the root cause location in the root cause history table 27 (the root cause apparatus name 2702 and the root cause component name 2703) matches the loop 2181 processing target root cause location. The solvability computation program 218 executes process 2184 in a case where the root cause location in the root cause history table 27 matches the loop 2181 processing target root cause location, and executes process 218b without executing the processes 2184 through 218a in a case where the root cause location in the root cause history table 27 does not match the loop 2181 processing target root cause location.

In process 2184, the solvability computation program 218 reads the root cause certainty factor 2704 and the performance failure 2706 that triggered the root cause analysis from the root cause history table 27, and executes the next process 2185.

In process 2185, the solvability computation program 218 performs loop processing in accordance with a start loop process 2185 and an end loop process 218a. This loop processing is implemented with respect to all the items of the performance impact factor table 28, and performs processes 2186 through 2189.

In process 2186, the solvability computation program 218 determines whether the root cause location (the root cause apparatus name 2802 and the root cause component name 2803) in the performance impact factor table 28 matches the root cause location. The solvability computation program 218 executes process 2187 in a case where the root cause location in the performance impact factor table 28 matches the root cause location, and executes process 218a without executing the processes 2187 through 2189 in a case where the root cause location in the performance impact factor table 28 does not match the root cause location.

In process 2187, the solvability computation program 218 reads the target configuration change 2804 and the performance impact factor 2806 from the performance impact factor table 28. Next, based on the read target configuration change 2804, the solvability computation program 218 reads the configuration change contents (the migration-source apparatus name 2502, the migration-destination apparatus name 2503, the migration time 2504, and the migration component name 2505) from the configuration change history table 25. Next, the solvability computation program 218 executes the process 2188.

In process 2188, the solvability computation program 218 multiplies the certainty factor 2704 read in process 2184 by the performance impact factor 2806 read in process 2187 to find the impact factor. In the combination method, multiplication alone may be used, or a fuzzy function or the like may be used to perform normalization. Next, the solvability computation program 218 executes the process 2189.

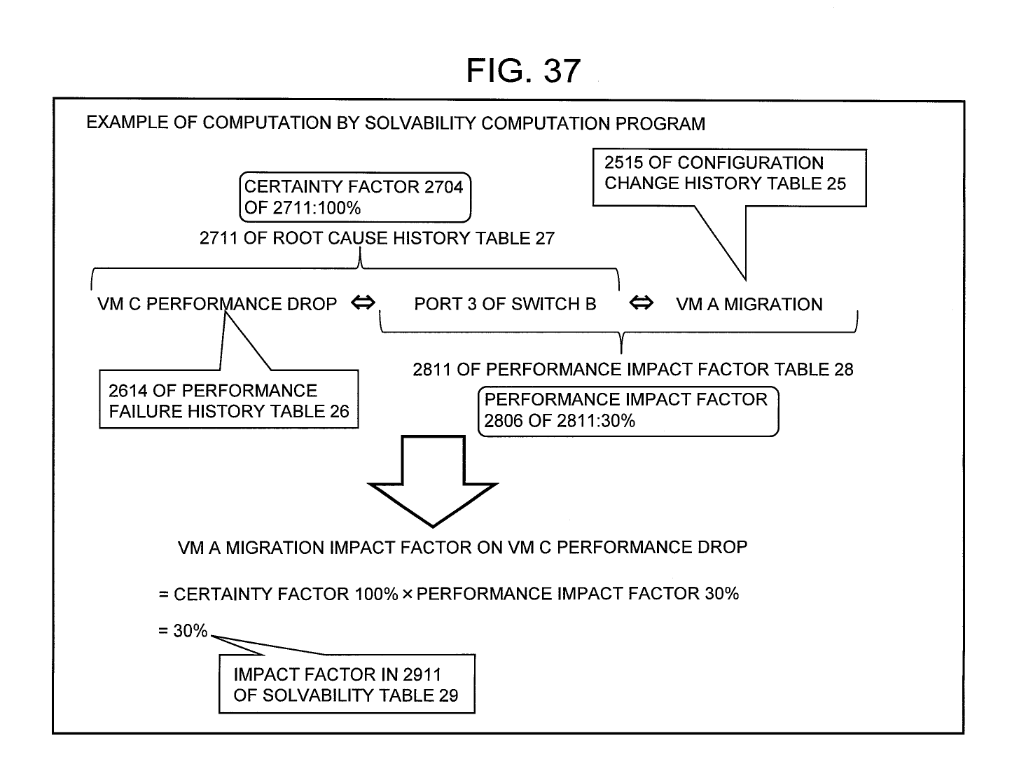

An example in which a sample computation of the solvability computation program of FIG. 37 is used to compute the impact factor from the certainty factor 2704 and the performance impact factor 2806 will be presented.

2711 of the root cause history table 27 will be used to provide a concrete example of the certainty factor 2704, and 2811 of the performance impact factor table 28 will be used to provide a concrete example of the performance impact factor 2806.

Based on the root cause apparatus name 2702 and the root cause component name 2703 of 2711, it is clear that the port 3 of the Switch B is the root cause. In addition, based on the performance failure 2706 that triggered the root cause analysis of 2711, it is clear that the performance failure of ID 4 triggered the root cause analysis. The ID 4 performance failure is 2614 of the performance failure history table 26, and denotes a drop in performance of the VM C on Server B.

Next, based on the root cause apparatus name 2802 and the root cause component name 2803 of 2811, it is clear that the port 3 of the Switch B is the root cause. In addition, based on the target configuration change of 2811, it is clear that the configuration change of ID 5 is the target configuration change 2804 of the root cause. The ID 5 configuration change is 2515 of the configuration change history table 25, and refers to the migration of the VM A.

Since the root cause in both 2711 and 2811 is the port 3 of the Switch B, it is possible to link the root cause analysis result with the performance impact computation result having port 3 of the Switch B as the base point. Specifically, it is possible to determine the impact that the migration of the VM A had on the drop in performance in the VM C by multiplying the certainty factor of 2711 by the performance impact factor of 2811. The result of multiplying the certainty factor of 2711 by the performance impact factor of 2811 is stored in 2911 of the solvability table 29.

The preceding ends the example for computing the impact factor based on the certainty factor 2704 and the performance impact factor 2806.

In process 2189, the solvability computation program 218 saves the triggering-performance failure 2706 as the triggering-performance failure 2902, saves the impact factor as the impact factor 2903, and saves the configuration change contents as the target configuration change 2904 in the solvability table 29.

In accordance with the above-described solvability computation program 218, the performance impact factors of the respective configuration changes are determined with respect to the performance failure and saved to the solvability table 29.

Next, the screen display program 219 will be explained.

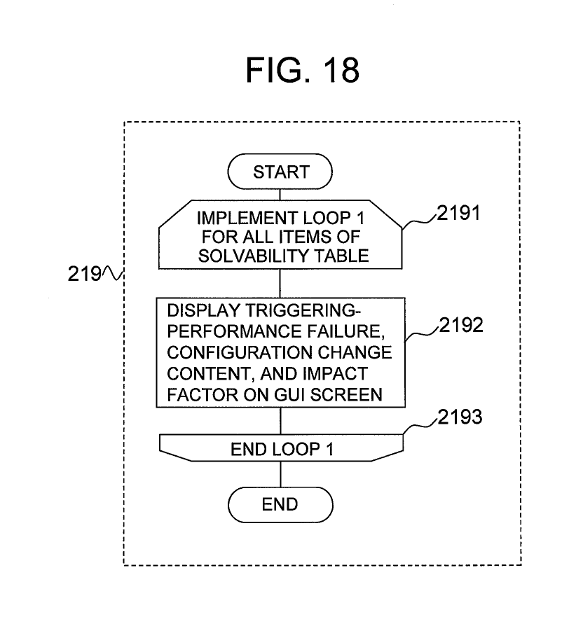

The screen display program 219 will be explained below on the basis of the processing flow of FIG. 18. This program is executed when a screen display is requested.

The screen display program 219 first performs loop processing in accordance with a start loop process 2191 and an end loop process 2193. In this loop processing, the screen display program 219 executes the process 2192 with respect to all the records of the solvability table 29. Furthermore, a solvability table 29 record constitutes a row of this table.

The process 2192, based on the record read from the solvability table 29 in process 2191, displays the triggering-performance failure 2902, the impact factor 2903, and the target configuration change 2904 on a GUI screen 31.

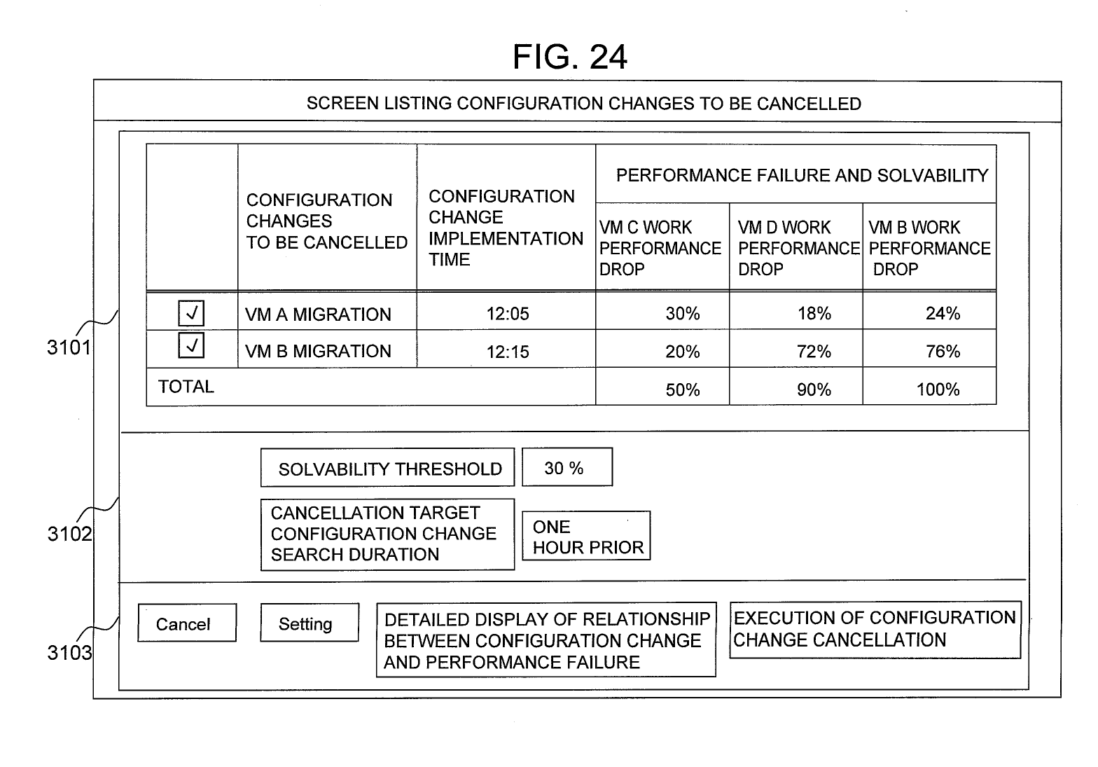

Examples of GUI screen 31 screen displays will be presented in FIGS. 24 through 26.

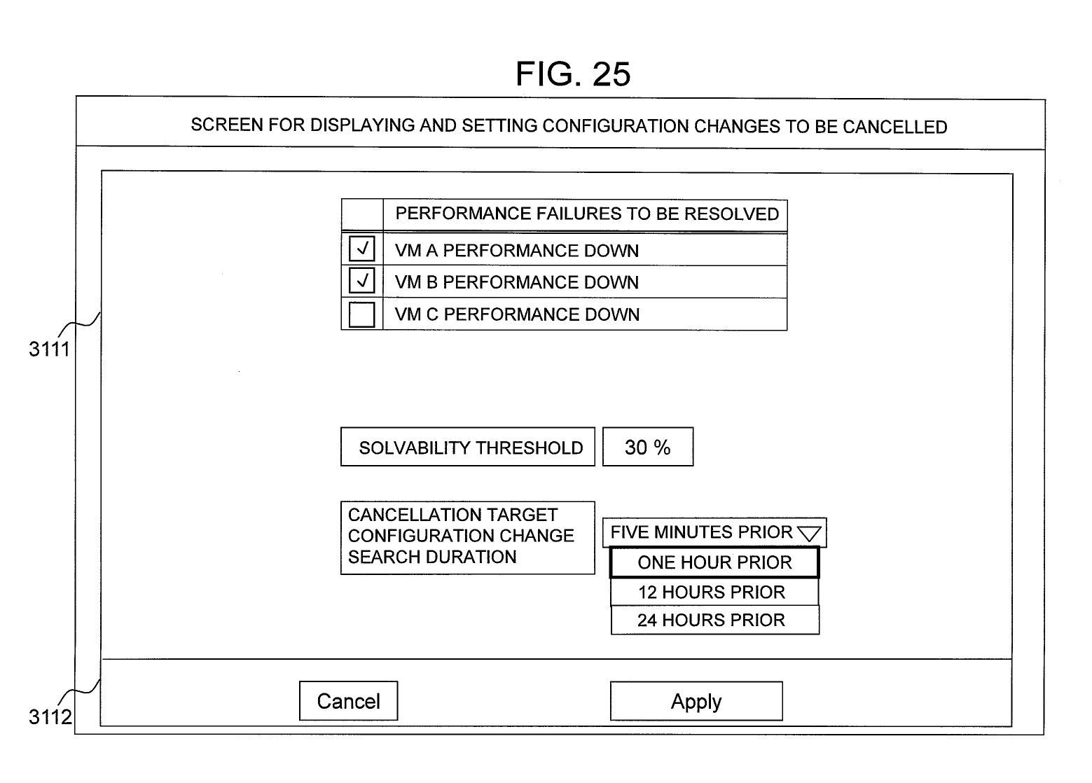

In FIG. 24, the solvability table data is displayed in 3101, the setting information of the contents displayed in 3101 is displayed in 3102, and the buttons pressed by the administrator 1 are displayed in 3103. The setting information displayed in 3102 is the information configured in the screen of FIG. 25. In a case where the solvability threshold of 3102 has been configured, a check is automatically configured in the configuration change to be cancelled so that the total displayed in 3101 exceeds the solvability threshold. In a case where the duration for searching for a cancellation target configuration change of 3102 has been configured, the configuration change to be cancelled displayed in 3101 is limited to a configuration change that occurred during the cancellation target configuration change search duration.

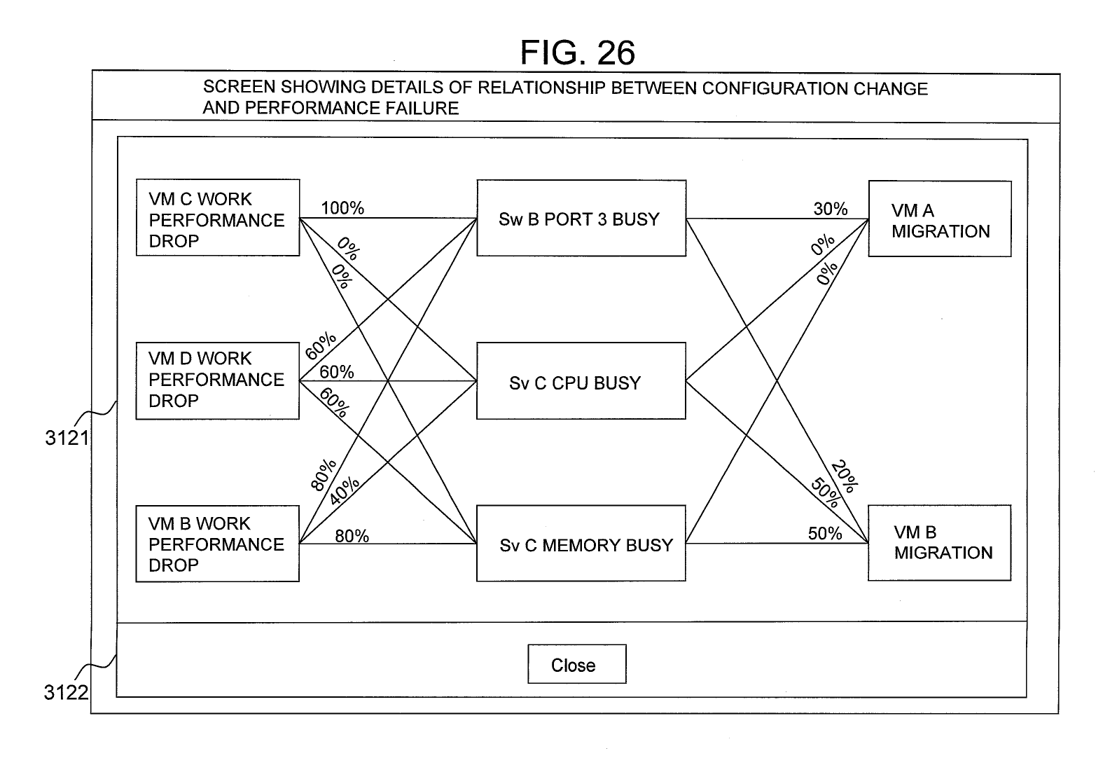

When a Cancel button of 3103 is pressed, this screen ends. When a Setting button of 3103 is pressed, the screen of FIG. 25 is displayed. When a detailed display of a configuration change-performance failure relationship button of 3103 is pressed, the screen of FIG. 26 is displayed. When an execute configuration change cancellation button of 3103 is pressed, a configuration change for which a check has been entered in the checkbox of 3101 is cancelled.

In FIG. 25, a screen for selecting a setting item displayed in FIG. 24 is displayed in 3111, and buttons pressed by the administrator 1 are displayed in 3112. A performance failure to be resolved of 3111 enables the selection of the performance failure and its solvability displayed in 3101 of FIG. 24. A solvability threshold of 3111 enables the selection of the solvability threshold displayed in 3102 of FIG. 24. A cancellation target configuration change search duration of 3111 enables the selection of the cancellation target configuration change search duration displayed in 3102 of FIG. 24. When a Cancel button of 3112 is pressed, this screen ends. When an Apply button of 3112 is pressed, the setting contents of this screen are reflected in FIG. 24.

In FIG. 26, details of the information displayed in 3101 of FIG. 24 are displayed in 3121, and a button pressed by the administrator 1 is displayed in 3122. The details of 3101 of FIG. 24 are displayed in 3121. In 3101 of FIG. 24, a configuration change to be cancelled and a performance failure are displayed together with the performance impact factor, but in 3121, the relationships between the performance failure, the root cause and the root cause, and the configuration change to be cancelled are also displayed, and a process for determining the performance impact factor is displayed. When a Close button of 3112 is pressed, this screen ends.

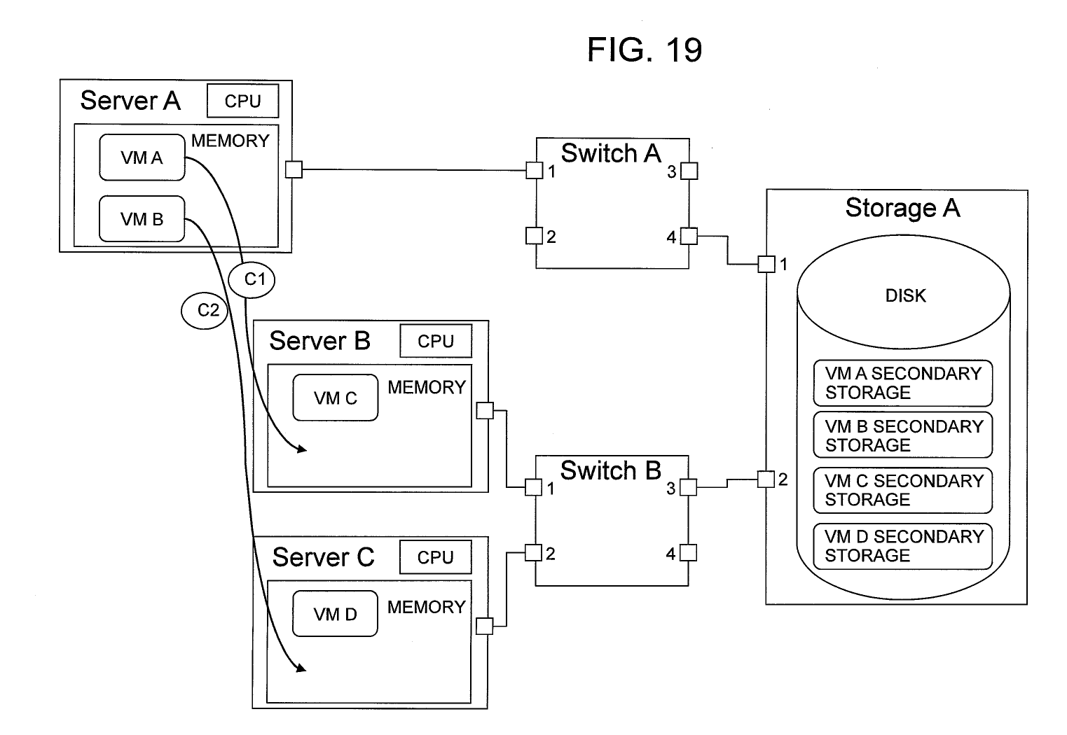

Next, schematic diagrams of the when the first example of the present invention has been put to use are shown in FIGS. 19 through 23.

FIG. 19 is a schematic diagram of when a configuration change occurs, and illustrates how a Server A, a Server B, a Server C, a Switch A, a Switch B, and a Storage A are coupled, and a VM A and a VM B, which are running on the Server A, migrate to the Server B and the Server C in accordance with configuration changes labeled C1 and C2.

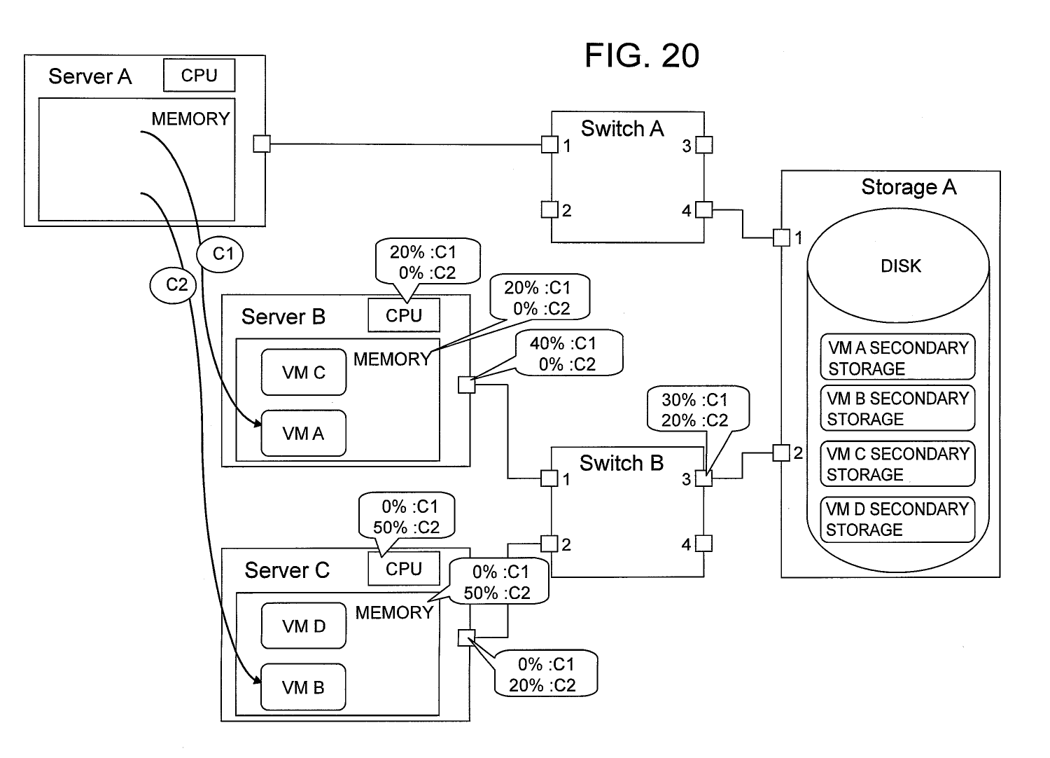

FIG. 20 is a schematic diagram of the performance impact factor computation, and uses balloons to illustrate the rate of increase in performance for each component before and after the occurrence of the configuration changes C1 and C2 of FIG. 19.

FIG. 21 is a schematic diagram showing the locations where performance failures have occurred, and illustrates how the performance failure events of E1 through E6 occurred after the passage of a fixed period of time subsequent to the execution of the configuration changes C1 and C2.

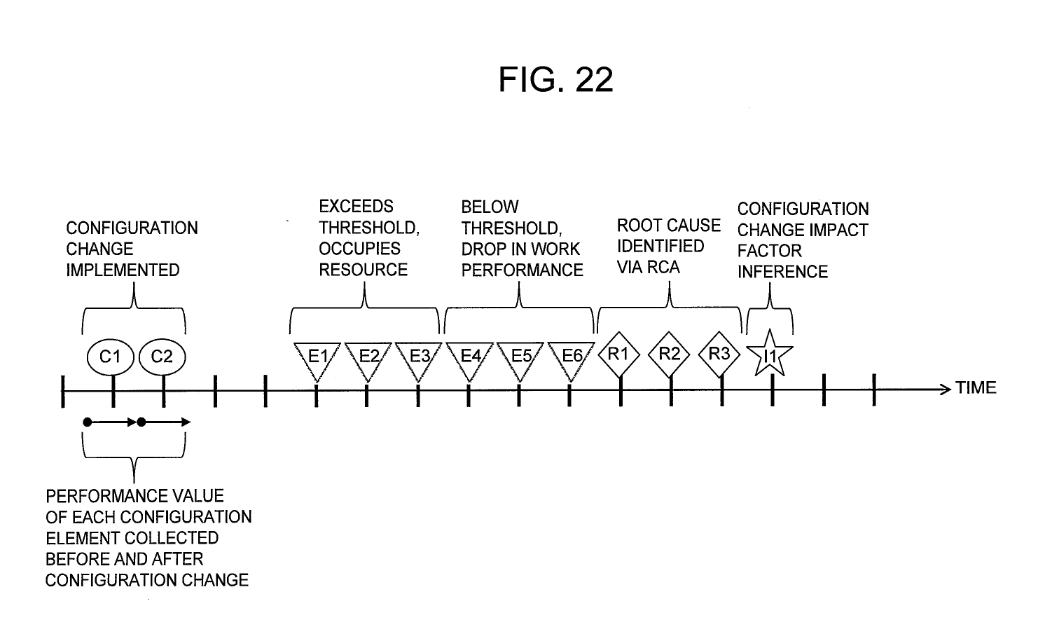

FIG. 22 is a time line of the configuration changes, performance failures, RCA, and impact factor inference, and illustrate on the time line when the configuration changes C1 and C2 occurred, when the performance failure events E1 through E6 occurred, when the root cause identifications R1 through R3 were performed in accordance with the RCA, which the first example of the present invention executed upon detecting the configuration change or a performance failure event, and when the configuration change impact factor inference Il took place.

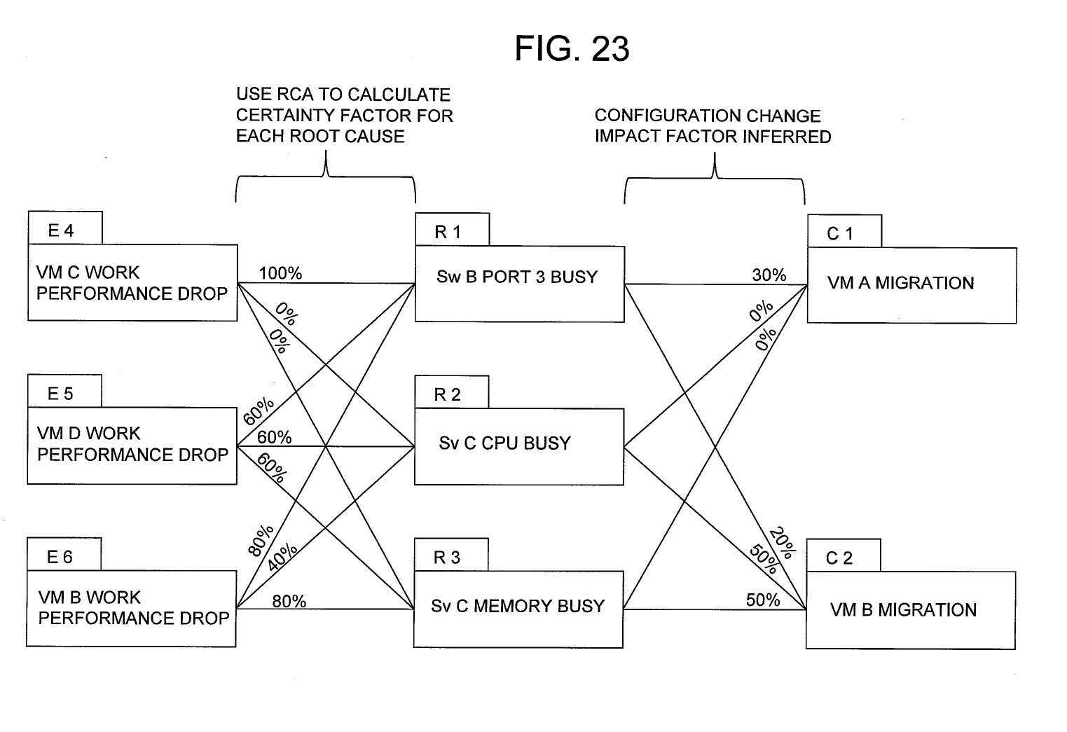

FIG. 23 is an RCA-impact factor inference association diagram, and illustrates the association of the certainty factor and the configuration change performance impact factor with respect to each root cause in accordance with the RCA for the performance failures E4 through E6, the RCA-based root cause identifications R1 through R3, and the configuration changes C1 and C2, respectively.

FIG. 23 will be used as an example to explain the characteristic feature of the first example of the present invention.

The characteristic feature of the first example of the present invention is to infer the relationship between a configuration change and a performance failure that has occurred in a case where the relationship between the performance failure that has occurred (the event) and the root cause location, and the relationship between the root cause location and the configuration change have been applied as conditions.

Focusing on E4, R1 and C1 of FIG. 23, the condition (if) and inference result (then) are as follows.

if

Condition 1: “Root cause of E4 is R1”

Condition 2: “Configuration change that places performance load on R1 location is C1”

then

Result: “Cancel C1 configuration change to resolve E4”

Actually, the inference is performed by also taking into account the probability of the root cause certainty factor and the probability of the configuration change impact factor.

Focusing on E4, R1 and C1 of FIG. 23 once again, the condition (if), the inference result (then), and the probabilities thereof are as follows.

if

Condition 1: “Root cause of E4 is R1” Probability: 100%

Condition 2: “Configuration change that places performance load on R1 location is C1” Probability: 30%

then

Result: “Cancel C1 configuration change to resolve E4”

Probability: 100 (%)×30 (%)=30%

Similarly, focusing on E4, R1 and C2 of FIG. 23, the condition (if), the inference result (then), and the probabilities thereof are as follows.

if

Condition 1: “Root cause of E4 is R1” Probability: 100%

Condition 2: “Configuration change that places performance load on R1 location is C2” Probability: 20%

then

Result: “Cancel C2 configuration change to resolve E4”

Probability: 100 (%)×20 (%)=20%

From the above, it is clear that it is better to cancel the C1 than the C2 to resolve the E4.

### EXAMPLE 2

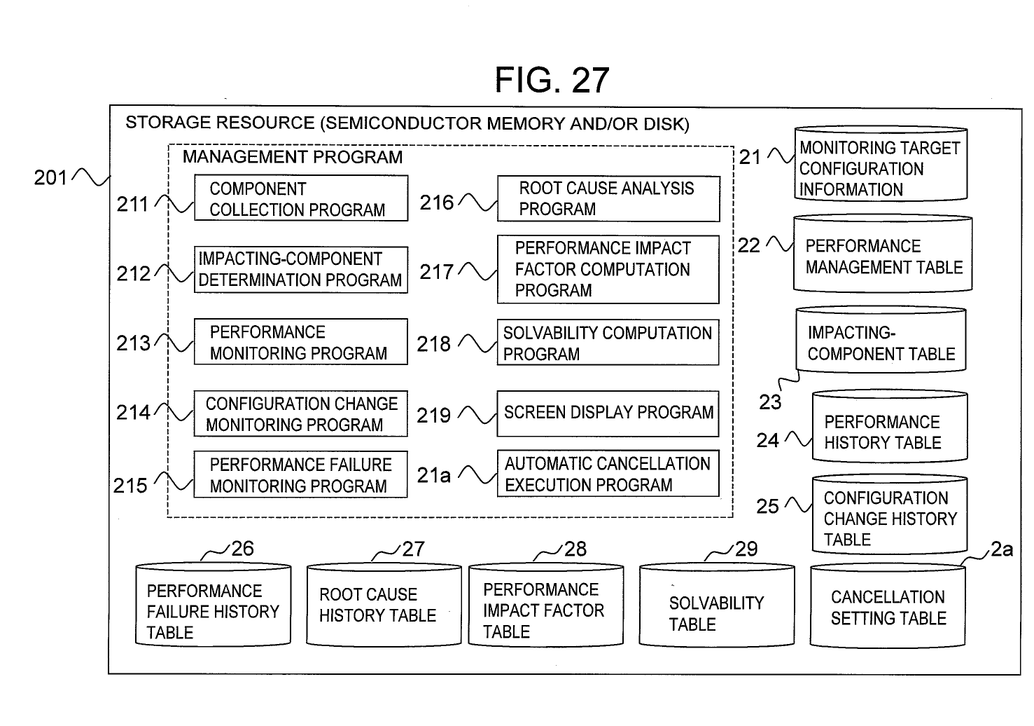

A second example of the present invention will be explained on the basis of FIGS. 27 through 29. The following examples, to include this example, are equivalent to variations of the first example. In the method of the first example, the performance failure is not eliminated until the administrator 1 executes a configuration change cancellation. In the second example, a cancellation setting table 2a and an automatic cancellation execution program 21a are provided, and a configuration change cancellation is executed automatically subsequent to the solvability computation. Based on the above, the characteristic feature of this example is that the configuration change cancellation is executed automatically without the need for the administrator 1 to execute a configuration change cancellation.

FIG. 27 shows that the automatic cancellation execution program 21a and cancellation setting table 2a are also stored in the storage resource 201 in the second example.

Next, the automatic cancellation execution program 21a will be explained.

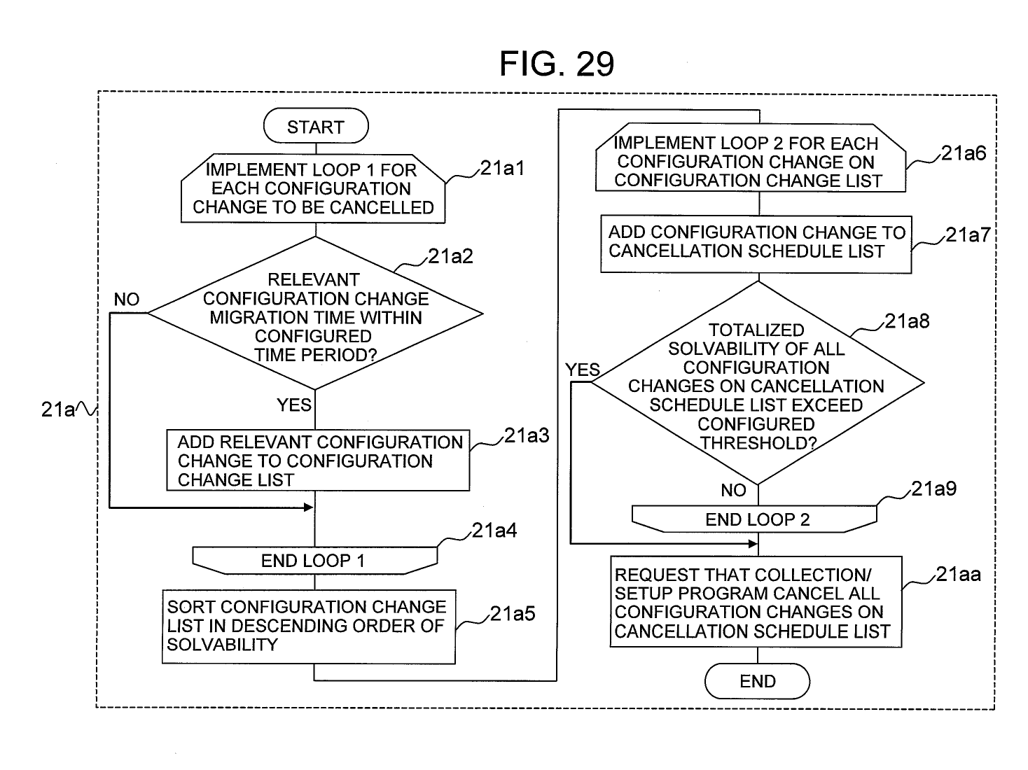

The automatic cancellation execution program 21a will be explained below on the basis of the processing flow of FIG. 29. Furthermore, this program may be executed in response to the solvability computation, but may also be executed in accordance with another trigger.

The automatic cancellation execution program 21a first performs loop processing in accordance with a start loop process 21a1 and an end loop process 21a4. In this loop processing, the automatic cancellation execution program 21a executes processes 21a2 through 21a3 with respect to each of one or more configuration changes to be cancelled in the solvability table 29.

In process 21a2, the automatic cancellation execution program 21a determines whether or not the migration time of the configuration change to be cancelled of the process 21a1 falls within the period of the configuration change search duration 2a03 in the cancellation setting table 2a. Furthermore, the migration time is determined by subtracting the 2504 in the configuration change history table 25 that matches the ID described in the 2904 of the solvability table 29. In a case where the migration time of the configuration change to be cancelled of the process 21a1 falls within the time period of the configuration change search duration 2a03 in the cancellation setting table 2a, the automatic cancellation execution program 21a executes the process 21a3, and in a case where the migration time of the configuration change to be cancelled of the process 21a1 does not fall within the time period of the configuration change search duration 2a03 in the cancellation setting table 2a, executes the process 21a4 without executing the process 21a3.

In process 21a3, the automatic cancellation execution program 21a adds the configuration change to be cancelled to a configuration change list (not shown in the drawing), and executes the next process 21a4.

In process 21a5, the automatic cancellation execution program 21a sorts the configuration change list (not shown in the drawing) in descending order by solvability, and executes the next process 21a6.

In process 21a6, the automatic cancellation execution program 21a performs loop processing in accordance with a start loop process 21a6 and an end loop process 21a9. In this loop processing, the automatic cancellation execution program 21a executes processes 21a7 through 21a8 with respect to the respective configuration changes to be cancelled in the configuration change list (not shown in the drawing).

In process 21a7, the automatic cancellation execution program 21a adds the configuration change to be cancelled to a cancellation schedule list (not shown in the drawing), and executes the next process 21a8.

In process 21a8, the automatic cancellation execution program 21a determines whether or not the totalized solvability of all the configuration changes to be cancelled on the cancellation schedule list (not shown in the drawing) exceeds the solvability threshold 2a02 in the cancellation setting table 2a. In a case where the totalized solvability of all the configuration changes to be cancelled on the cancellation schedule list (not shown in the drawing) do not exceed the solvability threshold 2a02 in the cancellation setting table 2a, the automatic cancellation execution program 21a executes the process 21a9, and in a case where the totalized solvability of all the configuration changes to be cancelled on the cancellation schedule list (not shown in the drawing) exceeds the solvability threshold 2a02 in the cancellation setting table 2a, executes process 21aa.

In process 21aa, the automatic cancellation execution program 21a requests that the collection/setup programs 46, 56 and 66 cancel all the configuration changes to be cancelled in the cancellation schedule list (not shown in the drawing).

In accordance with the above-described automatic cancellation execution program 21a, a configuration change to be cancelled is cancelled in accordance with a setting determined beforehand in the cancellation setting table 2a.

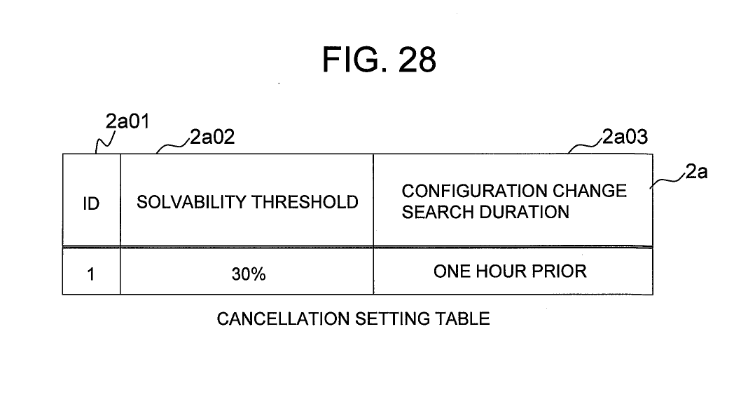

FIG. 28 shows the cancellation setting table 2a. Columns 2a01 through 2a03 are set beforehand by the administrator 1.

### EXAMPLE 3

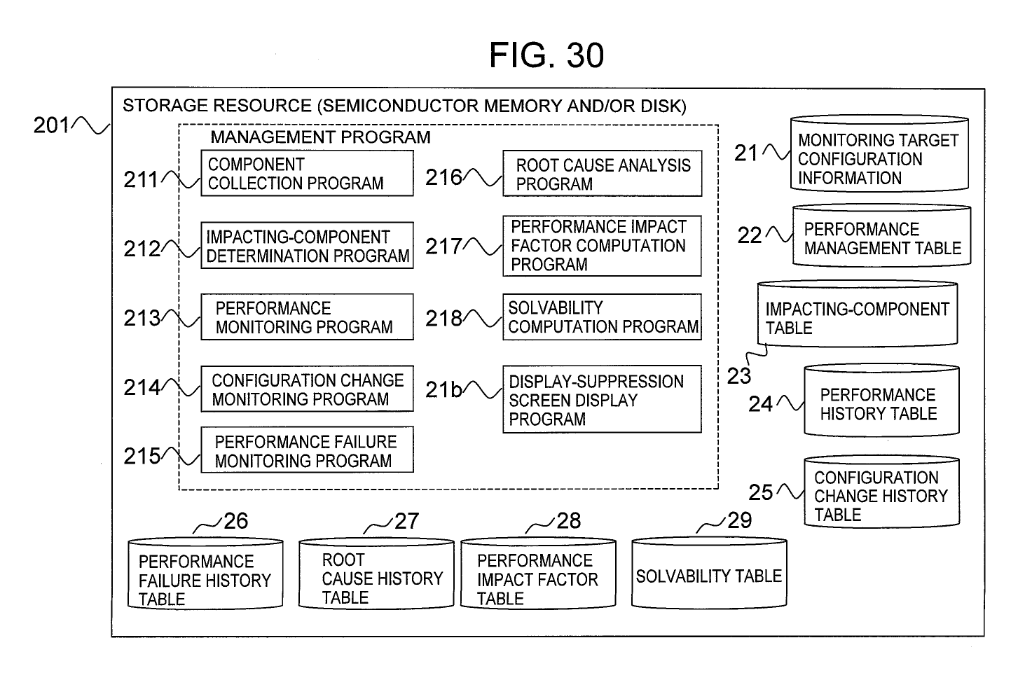

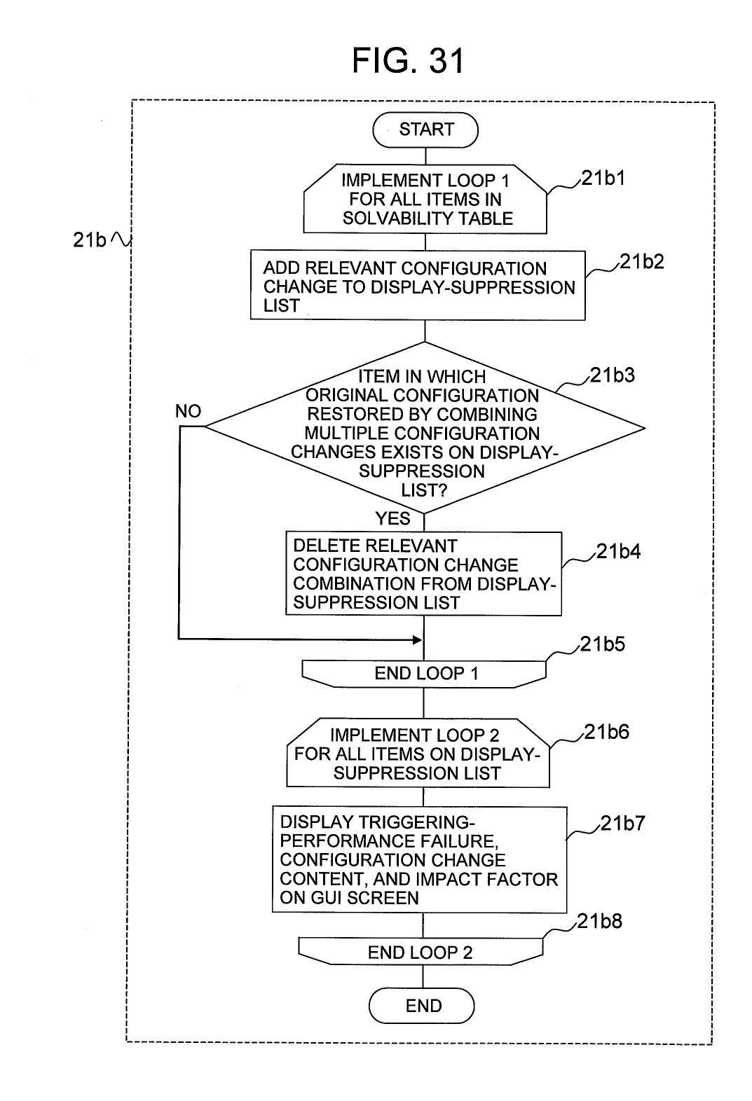

A third example of the present invention will be explained on the basis of FIGS. 30 and 31. In the method of the first example, in a case where a configuration, which returns to its original form by combining multiple configuration changes, is displayed on the GUI screen 31, there is the likelihood of the administrator 1 executing an unnecessary configuration change. For example, in a case where a configuration change in which a VM is migrated from the Server A to the Server B and a configuration change in which the VM is migrated from the Server B to the Server A are displayed on the GUI screen 31, two configuration changes that need not be made will be performed in a case where the administrator 1 mistakenly selects this configuration change. In the third example, a display suppression screen display program 2b is provided, and is used to prevent the administrator 1 from mistakenly instructing an unnecessary configuration change cancellation by removing the unnecessary configuration change when same is displayed on the GUI screen 31.

Based on the above, the characteristic feature of this example is the suppression of an unnecessary configuration change instruction by the administrator 1 without displaying a configuration that returns to its original form by combining multiple configuration changes.

FIG. 30 shows that the display suppression screen display program 21b is stored in the storage resource 201 in the third example.

Next, the display suppression screen display program 21b will be explained.

The display suppression screen display program 21b will be explained below on the basis of the processing flow of FIG. 31.

The display suppression screen display program 21b first performs loop processing in accordance with a start loop process 21b1 and an end loop process 21b5. In this loop processing, the display suppression screen display program 21b executes processes 21b2 through 21b4 with respect to the respective configuration changes to be cancelled in the solvability table 29.

In process 21b2, the display suppression screen display program 21b adds a configuration change to be cancelled to a display suppression list (not shown in the drawing).

In process 21b3, the display suppression screen display program 21b determines whether or not a configuration that returns to its original form by combining multiple configuration changes in the display suppression list (not shown in the drawing) is in the display suppression list. In a case where a configuration that returns to its original form by combining multiple configuration changes in the display suppression list (not shown in the drawing) is in the display suppression list, the display suppression screen display program 21b executes the process 21b4, and in a case where a configuration that returns to its original form by combining multiple configuration changes in the display suppression list (not shown in the drawing) is not in the display suppression list, executes the process 21b5.

In process 21b4, the display suppression screen display program 21b deletes the configuration change combination found in process 21b3 from the display suppression list.

Next, the display suppression screen display program 21b performs loop processing in accordance with a start loop process 21b6 and an end loop process 21b8. In this loop processing, the display suppression screen display program 21b executes process 21b7 with respect to all the items in the display suppression list (not shown in the drawing).

In process 21b7, the display suppression screen display program 21b displays the triggering-performance failure 2902, the impact factor 2903, and the target configuration change 2904 that were read from the display suppression list (not shown in the drawing) on the GUI screen 31.

In accordance with the above explanations, it was explained that the management system of examples 1 through 3

(*) is coupled to multiple monitoring target apparatuses, a portion of which are multiple server computers providing multiple service components, and which are either multiple hardware components or comprise multiple hardware components, and

(*) comprises a CPU, a display device, and a memory resource, which stores performance information denoting a multiple hardware performance status that indicates multiple performance statuses of the multiple hardware components, and a multiple services performance status that indicates multiple performance statuses of the above-mentioned multiple service components, and historical information denoting the history of multiple migrations of the above-mentioned multiple service components between the above-mentioned multiple server computers.

(*) The above-mentioned memory resource stores rule information denoting multiple conditions with respect to the above-mentioned multiple hardware performance status and/or the above-mentioned multiple services performance status, and a root cause hardware performance status of a root cause hardware component, which is in an overload status, as the root cause of the service performance status associated with the conditions.

(*) With respect to a first service performance status, which is the performance status, and the performance failure status of a first service component, the above-mentioned CPU computes a hardware component level certainty factor for the fact that a first hardware performance status is the above-mentioned root cause hardware performance status.

(*) The above-mentioned CPU, based on the above-mentioned historical information, the above-mentioned performance information, and the above-mentioned hardware component level certainty factor, computes a performance impact factor for the fact that a predetermined migration of the above-mentioned first service component is the root cause of the above-mentioned first service performance status.

(*) The above-mentioned CPU, based on the above-mentioned performance impact factor, displays management information via the above-mentioned display device.

Furthermore, it was explained that the above-mentioned multiple hardware components may be either the above-mentioned multiple monitoring target apparatuses or multiple pieces of hardware included in the above-mentioned monitoring target apparatus, or may be a mix of the above-mentioned multiple monitoring target apparatuses and multiple pieces of hardware included in the above-mentioned monitoring target apparatus.

Furthermore, it was explained that, with respect to at least two or more of the above-mentioned multiple migrations including the above-mentioned predetermined migration, the above-mentioned CPU computes two or more performance impact factors including the above-mentioned performance impact factor, and as the above-mentioned management information display, the above-mentioned CPU:

(A) may select a migration from the above-mentioned two or more migrations based on the above-mentioned two or more performance impact factors;

(B) may select a service component corresponding to the migration selected in the above-mentioned (A); and

(C) in order to resolve the above-mentioned first service performance status, may cause the above-mentioned display device to display a display for recommending the identifier of the service component selected in the above-mentioned (B), and a migration of the service component selected in the above-mentioned (B) from the server computer that is currently providing same.

Furthermore, it was explained that the above-mentioned CPU may also cause to display information denoting that the first hardware performance status has either been identified or inferred as the root cause of the above-mentioned first service performance status, and information on the above-mentioned hardware component level certainty factor.

Furthermore, it was explained that the above-mentioned CPU: (D) may identify a service component from the service components selected in the above-mentioned (B) either automatically or based on an instruction from a user of the above-mentioned management system, and (E): may send a migration request for migrating the service component identified in the above-mentioned (D).

Furthermore, it was explained that the above-mentioned CPU may select a subset of the above-mentioned multiple migrations in which the service component selected in the above-mentioned (B) migrates from the current server computer to the above-mentioned current server computer, and may suppress the migration, which is included in the above-mentioned subset, from being included within the service components identified in the above-mentioned (D).

The management system is also able to resolve the following kinds of problems.

(A) There are cases in which even though the root cause has been identified and the user is experienced enough to know the method for avoiding a performance failure, time is needed to implement this workaround. For example, in a case where the root cause has been identified as a performance failure of a switch that couples a business server and a storage apparatus, in order to change the system configuration and avoid the performance failure, a new switch with outstanding performance must be ordered and installed. However, ordering and installation will take at least several days, the performance failure that is currently occurring will continue for several days, and the impact on the user's work will be enormous.

(B) There may also be cases where multiple root causes are conceivable, and cases where it is not obvious which root cause should be eliminated in order to avoid a performance failure. There may also be cases where a perceived probability of the cause, called a certainty factor, is applied to each root cause. However, since the certainty factor is nothing more than a probability, it is not always possible to avoid a performance failure even when the root cause with the highest certainty factor is eliminated.

### REFERENCE SINGS LIST

1 Administrator

2 Management computer

201 Storage resource

202 CPU

203 Disk

204 Interface device

3 Display computer

6 Storage

7 LAN

8 SAN

1. A management system coupled to multiple monitoring target apparatuses, a portion of which are multiple server computers providing multiple service components, and which are either multiple hardware components or comprise multiple hardware components, the management system comprising:
a memory resource for storing performance information denoting a multiple hardware performance status that indicates multiple performance statuses of the multiple hardware components, and a multiple services performance status that indicates multiple performance statuses of the multiple service components, and historical information denoting the history of multiple migrations of the multiple service components between the multiple server computers;
a CPU; and
a display device,
wherein the memory resource stores rule information denoting multiple conditions with respect to the multiple hardware performance status and/or the multiple services performance status, and a root cause hardware performance status of a root cause hardware component, which is in an overload status, as the root cause of the service performance status associated with the conditions,
wherein the CPU, based on the performance information and the rule information, computes a hardware component level certainty factor for the fact that a first hardware performance status is the root cause hardware performance status with respect to a first service performance status, which is the performance status, and the performance failure status of a first service component,
wherein the CPU, based on the historical information, the performance information, and the hardware component level certainty factor, computes a performance impact factor for that fact that a predetermined migration of the first service component is the root cause of the first service performance status and
wherein the CPU, based on the performance impact factor, displays management information via the display device.

2. A management system according to claim 1,
wherein the multiple hardware components are either the multiple monitoring target apparatuses or multiple pieces of hardware included in the monitoring target apparatus, or a mix of the multiple monitoring target apparatuses and multiple pieces of hardware included in the monitoring target apparatus.

3. A management system according to claim 1,
wherein, with respect to at least two or more of the multiple migrations including the predetermined migration, the CPU computes two or more performance impact factors including the performance impact factor, and as the management information display, the CPU:
(A) selects a migration from the two or more migrations based on the two or more performance impact factors;
(B) selects a service component corresponding to the migration selected in the (A); and
(C) in order to resolve the first service performance status, causes the display device to display a display for recommending the identifier of the service component selected in the (B), and a migration of the service component selected in the (B) from the server computer that is currently providing same.

4. A management system according to claim 1,
wherein the CPU displays information denoting that a first hardware performance status has either been identified or inferred as the root cause of the first service performance status, and information on the hardware component level certainty factor.

5. A management system according to claim 4,
wherein the CPU:
(D) identifies a service component from the service components selected in the (B) either automatically or based on an instruction from a user of the management system; and
(E) sends a migration request for migrating the service component identified in the (D).

6. A management system according to claim 1,
wherein at least one of the multiple service components is a virtual machine.

7. A management system according to claim 5,
wherein the CPU selects a subset of the multiple migrations in which the service component selected in the (B) migrates from the current server computer to the current server computer, and
wherein the CPU suppresses the migration, which is included in the subset, from being included within the service component identified in the (D).

8. A management method for a target apparatus in a computer system comprising management target apparatuses, a portion of which are server computers providing service components, and a management system, the management method comprising: in use of the management system,
(1) receiving performance information of the service component, and a hardware component, which is either the monitoring target apparatus or a component of the monitoring target apparatus;
(2) receiving information enabling the acquisition of a migration history of the service component between the server computers;
(3) computing a performance impact factor denoting the probability of the migration of a predetermined service component being the root cause of a predetermined performance status related to the predetermined service component based on the information received in the (1) and the (2); and
(4) displaying management information, based on the performance impact factor, on the display device comprising the management system.

9. A management method according to claim 8,
wherein the component is the monitoring target apparatus, a piece of hardware of the monitoring target apparatus, or a mix of the monitoring target apparatus and a piece of hardware of the monitoring target apparatus.

10. A management method according to claim 9,
wherein the management system:
(5) selects at least one migration from the information received in the (2) based on the performance impact factor;
(6) identifies a service component identified in accordance with the migration selected in the (5); and
(7) displays on the display device information recommending the migration of the service component identified in the (6) in order to resolve the predetermined performance status related to the predetermined service component.

11. A management method according to claim 10,
wherein the management system sends a migration request that identifies a portion of the recommended service components.

12. A management system according to claim 8,
wherein the service component is a virtual machine.

13. A management system according to claim 11, the management method further comprising: in use of the management system,
(8) identifying from the information received in the (2) an aggregate of migrations denoting that the service component identified in the (6) migrates from a current server computer to the current server computer once again; and
(9) suppressing the sending of a migration request that returns the service component migration included in the aggregate identified in the (8).
